(19) United States
(12) Patent Application Publication
(10) Pub. No.: US 2025/0209603 A1
(43) Pub. Date: Jun. 26, 2025

(54) COMPUTER IMPLEMENTED METHOD FOR DEFECT RECOGNITION IN AN IMAGING DATASET OF A WAFER, CORRESPONDING COMPUTER READABLE-MEDIUM, COMPUTER PROGRAM PRODUCT AND SYSTEMS MAKING USE OF SUCH METHODS

(71) Applicant: Carl Zeiss SMT GmbH, Oberkochen (DE)

(72) Inventors: Abhilash SRIKANTHA, Neu-Ulm (DE); Thomas KORB, Schwaebisch Gmuend (DE)

(21) Appl. No.: 19/078,756

(22) Filed: Mar. 13, 2025

Related U.S. Application Data
(63) Continuation of application No. PCT/EP2023/074366, filed on Sep. 6, 2023.

(30) Foreign Application Priority Data
Sep. 23, 2022 (DE) 10 2022 124 580.2

(51) Int. Cl. G06T 7/00

(52) U.S. Cl. CPC G06T 7/0004; G06T 2207/20081; G06T 2207/20084; G06T 2207/30148

(57) ABSTRACT

A computer implemented method for defect recognition in an imaging dataset of a wafer in a charged particle beam system comprising an embedded system, the method comprising: i) obtaining an imaging dataset of a wafer; ii) obtaining model data for a model architecture of a machine learning model for defect recognition in the imaging dataset of the wafer, the model architecture being implemented in the embedded system; iii) transferring the model data to a programmable memory of the embedded system; and iv) applying the machine learning model to an imaging dataset of a wafer to recognize defects, comprising executing the embedded system implemented model architecture with the transferred model data.

### CROSS-REFERENCE TO RELATED APPLICATIONS

The present application is a continuation of, and claims benefit under 35 USC 120 to, international application No. PCT/EP2023/074366, filed Sep. 6, 2023, which claims benefit under 35 USC 119 of German Application No. 10 2022 124 580.2, filed Sep. 23, 2022. The entire disclosure of each of these applications is incorporated by reference herein.

### FIELD

The disclosure relates to systems and methods for quality control and quality assurance for semiconductor structures, more specifically to a computer implemented method, a computer-readable medium and corresponding systems for defect recognition in an imaging dataset of a wafer with increased throughput. The method, computer-readable medium and systems are based on an implementation of generic machine learning models in embedded systems. The methods can be utilized for quantitative metrology, defect recognition, defect detection, defect classification, defect localization, or defect review of integrated circuits within semiconductor wafers or for process monitoring, process improvement, quality control or quality assurance during the production of semiconductor wafers.

### BACKGROUND

Semiconductor manufacturing generally involves precise manipulation, e.g., etching, of materials such as silicon or oxide at very fine scales in the range of nm. Therefore, a quality management process comprising quality assurance and quality control is relevant for ensuring high quality standards of the manufactured wafers. Quality assurance refers to a set of activities for ensuring high-quality products by preventing any defects that may occur in the development process. Quality control refers to a system of inspecting the final quality of the product. Quality control is part of the quality assurance process.

A wafer made of a thin slice of silicon typically serves as the substrate for microelectronic devices containing semiconductor structures built in and upon the wafer. The semiconductor structures are constructed layer by layer using repeated processing steps that involve repeated chemical, mechanical, thermal and optical processes. Dimensions, shapes and placements of the semiconductor structures and patterns are subject to several influences. For example, during the manufacturing of 3D-memory devices, the processes currently include etching and deposition. Other process steps such as the lithography exposure or implantation also can have an impact on the properties of the elements of the integrated circuits. Therefore, fabricated semiconductor structures can suffer from rare and different imperfections. Devices for quantitative metrology, defect-detection or defect review look for these imperfections. These devices are not only involved during wafer fabrication. As this process is complicated and highly non-linear, optimization of production process parameters can be difficult. As a remedy, an iteration scheme called process window qualification (PWQ) can be applied. In each iteration a test wafer is manufactured based on the currently best process parameters, with different dies of the wafer being exposed to different manufacturing conditions. By detecting and analyzing the defects in the different dies based on a quality assurance process, the best manufacturing process parameters can be selected. In this way, production process parameters can be tweaked towards optimality. Afterwards, a highly accurate quality control process and device for the metrology semiconductor structures in wafers is used.

The recognized defects are, thus, used for root cause analysis. They can serve as feedback to improve the process parameters of the manufacturing process during quality assurance, e.g., exposure time, focus variation, etc, or they can serve for ensuring the quality of manufactured wafers during quality control. For example, bridge defects can indicate insufficient etching, line breaks can indicate excessive etching, consistently occurring defects can indicate a defective mask and missing structures hint at non-ideal material deposition etc.

Fabricated semiconductor structures are generally based on prior knowledge. The semiconductor structures are manufactured from a sequence of layers being parallel to a substrate. For example, in a logic type sample, metal lines are running parallel in metal layers or HAR (high aspect ratio) structures and metal vias run perpendicular to the metal layers. The angle between metal lines in different layers is either 0° or 90°. On the other hand, for VNAND type structures it is known that their cross-sections are circular on average. Furthermore, a semiconductor wafer can have a diameter of 300 millimeters (mm) and includes a plurality of several sites, so called dies, each comprising at least one integrated circuit pattern such as for example for a memory chip or for a processor chip. During fabrication, semiconductor wafers run through about 1000 process steps, and within the semiconductor wafer, about 100 and more parallel layers are formed, comprising the transistor layers, the layers of the middle of the line, and the interconnect layers and, in memory devices, a plurality of 3D arrays of memory cells.

The aspect ratio and the number of layers of integrated circuits constantly increases and the structures are growing into the third (vertical) dimension. The current height of the memory stacks is exceeding a dozen of microns. In contrast, the features size is becoming smaller. The minimum feature size or critical dimension is below 10 nanometers (nm), for example 7 nm or 5 nm, and is approaching feature sizes below 3 nm in near future. While the complexity and dimensions of the semiconductor structures are growing into the third dimension, the lateral dimensions of integrated semiconductor structures are becoming smaller. Therefore, measuring the shape, dimensions and orientation of the features and patterns in 3D and their overlay with high precision can become challenging. The lateral measurement resolution of charged particle systems is typically limited by the sampling raster of individual image points or dwell times per pixel on the sample, and the charged particle beam diameter. The sampling raster resolution can be set within the imaging system and can be adapted to the charged particle beam diameter on the sample. The typical raster resolution is 2 nm or below, but the raster resolution limit can be reduced with no physical limitation. The charged particle beam diameter usually has a limited dimension, which depends on the charged particle beam operation conditions and lens. The beam resolution is limited by approximately half of the beam diameter. The lateral resolution can be below 2 nm, for example even below 1 nm.

A task of semiconductor inspection is to determine a set of specific parameters of semiconductor objects such as high aspect ratio (HAR)—structures inside the inspection volume. Such parameters are for example a dimension, area, a shape, or other measurement parameters. Typically, the known measurement task involves several computational steps like object detection, feature extraction, and any kind of a metrology operation, for example a computation of a distance, a radius or an area from the extracted features. Of these many steps, each usually involves a high computational effort.

Generally, semiconductors comprise many repetitive three-dimensional structures. During the manufacturing process or a process development, some selected physical or geometrical parameters of a representative plurality of the three-dimensional structures have to be measured with high accuracy and high throughput. For monitoring the manufacturing, an inspection volume is defined, comprising the representative plurality of the three-dimensional structures. This inspection volume is then analyzed for example by a slice and image approach, leading to a 3D volume image of the inspection volume with high resolution obtained by slicing and imaging a plurality of cross-section surfaces within the inspection volume.

The plurality of repetitive three-dimensional structures inside an inspection volume can exceed several 100 or even several thousand individual structures. Thereby, a huge number of cross section images is generated, for example at least 100 three-dimensional structures are investigated by 100 cross section image slices, thus the number of measurements to be performed may easily reach 10,000 or more.

In addition, current technologies such as multibeam scanning electron microscopy (multibeam SEM) can be used for imaging large regions of a wafer surface with high resolution in a short period of time. To this end, multibeam SEM uses multiple single beams in parallel, each beam covering a separate portion of a surface, with pixel sizes down to 2 nm. The resulting datasets are huge and cannot be analyzed manually.

In order to analyze large amounts of data involving large amounts of measurements to be taken machine learning methods can be used. These are suitable for analyzing large amounts of data while limiting interaction with a user to a minimum.

Machine learning is a field of artificial intelligence. Machine learning methods generally build a parametric machine learning model based on training data consisting of a large number of samples. After training, the method is able to generalize the knowledge gained from the training data to new previously unencountered samples, thereby making predictions for new data. There are many machine learning methods, e.g., linear regression, k-means, neural networks or deep learning approaches.

Deep learning is a class of machine learning that uses artificial neural networks with numerous hidden layers between the input layer and the output layer modeled after the human brain. Due to this extensive internal structure the networks are able to progressively extract higher-level features from the raw input data. Each level learns to transform its input data into a slightly more abstract and composite representation, thus deriving low and high level knowledge from the training data. The hidden layers can have differing sizes and tasks such as convolutional layers, pooling layers or fully connected layers.

During quality control and quality assurance, the speed of the algorithms is a relevant factor, in order to achieve a high throughput of wafers. To obtain high speed algorithms, embedded systems can be used to implement machine learning models for quality assurance and quality control of acquired imaging datasets of wafers.

US 2021/0097673 A1 and US 2021/0158498 A1, for example, both disclose machine learning models for defect recognition in imaging datasets of wafers, which can be implemented using embedded systems such as FPGAs.

For software running on conventional processors numerous pre-programmed libraries are available to minimize the programming effort and time. For embedded systems this is not the case. In addition, each software update involves re-programming the embedded system. Therefore, programming an embedded system can involve considerable programming effort and time.

### SUMMARY

The disclosure seeks to provide methods of obtaining machine learning models on embedded systems that are reusable and versatile for different use-cases or varying imaging datasets. The disclosure seeks to reduce the effort, time and resources used for programming machine learning models on embedded systems for defect recognition in imaging datasets of wafers. The disclosure seeks to reduce the computation time of machine learning models. The disclosure seeks to adapt machine learning models on embedded systems to quality control or quality assurance processes for wafers. The disclosure seeks to increase the throughput during quality control or quality assurance processes for wafers. The disclosure seeks to minimize runtimes of quality control or quality assurance processes for wafers. Generally, the disclosure seeks to provide a wafer inspection method for the measurement of semiconductor structures in inspection volumes with high throughput and high accuracy. The disclosure seeks to provide a generalized wafer inspection method for the measurement of semiconductor structures in inspection volumes, which can quickly be adapted to changes of the measurement tasks, the measurement system, or to changes of the semiconductor object of interest. The disclosure seeks to provide a fast, robust and reliable measurement method of a set of parameters describing semiconductor structures in an inspection volume with high precision and with reduced measurement artefacts. The disclosure seeks to enable new business models for selling systems involving machine learning algorithms.

Embodiments of the disclosure concern computer implemented methods, computer-readable media and systems implementing machine learning models on embedded systems for defect recognition in imaging datasets of wafers.

A first embodiment involves a computer implemented method for defect recognition in an imaging dataset of a wafer in a charged particle beam system comprising an embedded system, the method comprising: i) obtaining an imaging dataset of a wafer; ii) obtaining model data for a model architecture of a machine learning model for defect recognition in the imaging dataset of the wafer, the model architecture being implemented in the embedded system; iii) transferring the model data to a programmable memory of the embedded system; iv) applying the machine learning model to an imaging dataset of a wafer to recognize defects, comprising executing the embedded system implemented model architecture with the transferred model data. The recognized defects can, for example, be used in a quality assurance system and/or in a quality control system, such as for wafers, but also for other manufactured objects.

A machine learning model is the result of a machine learning method run on training data. The model represents what was learned by the machine learning method. It comprises a model architecture, model data and a prediction method.

The model architecture comprises so called hyperparameters defining the design or structure of the machine learning model, which are typically not learned from training data. Hyperparameters can, for example, be defined by a user or obtained using AutoML methods. Hyperparameters of a neural network comprise, for example, the number of layers, layer sizes, filter types, optimizers, up-sampling schemes, etc. Hyperparameters of decision trees comprise, for example, the number of tree levels and the number of decision nodes on each tree level. Hyperparameters of support vector machines comprise, for example, the number and format of the hyperplanes. Hyperparameters of clustering methods comprise, for example, the number of clusters.

The model data contains rules, numbers or any other method-specific data structures used to make predictions for new data samples. The model data is learned from training data. Model data of a neural network comprises, for example, the weights that are learned from training data. Model data of a decision tree comprises, for example, the specific decisions taken at each node that are learned from training data. Model data of a support vector machine comprises, for example, matrices and vectors defining the specific hyperplanes learned from training data. Model data of clustering methods comprises, for example, the specific cluster locations that are learned from training data.

The prediction method is a procedure indicating how to use the model data to make predictions on new data. The application of a machine learning method or a machine learning model to an imaging dataset means the application of the prediction method based on the trained model comprising the model architecture and the model data to the imaging dataset.

Due to the separation of the model architecture from the learned model data, the model architecture can be implemented on an embedded system, in order to obtain low runtimes and high throughput. On the other hand, the learned model data in the programmable memory of the embedded system can be dynamically updated. In this way, the machine learning model on the embedded system can be adapted to a different use-case or re-trained, for example in case of varying imaging datasets. Varying imaging datasets can, for example, occur if image acquisition conditions change or the imaging datasets are modified. Furthermore, the implementation effort for the user is reduced.

The second embodiment of the disclosure concerns a computer implemented method for defect recognition in an imaging dataset of a wafer in a charged particle beam system comprising at least one embedded system, the method comprising: i) obtaining an imaging dataset of a wafer; ii) defining an embedded system implemented model architecture of a machine learning model for defect recognition in the imaging dataset of the wafer by specifying a flow of data through a number of logic block circuits of a plurality of logic block circuits on one of the at least one embedded systems, wherein the plurality of logic block circuits comprise one or more modules of at least one model architecture of at least one machine learning model for defect recognition; iii) obtaining model data for the embedded system implemented model architecture; iv) transferring the model data to a programmable memory of the embedded system; v) applying the machine learning model to the imaging dataset of a wafer to recognize defects, comprising executing the embedded system implemented model architecture with the transferred model data.

The recognized defects can, for example, be used in a quality assurance system and/or in a quality control system, such as for wafers, but also for other manufactured objects. Due to the modularity of the model architectures, the implementation of machine learning models on embedded systems becomes even more flexible and versatile, since different modules can be combined to form new model architectures and previously implemented modules can be reused for different model architectures. In this way, not only the model data but also the model architecture can be dynamically modified or adapted to a different use-case without involving a high implementation effort.

Throughout this document, the term “a number of” elements refers to a single one, several or all of the elements.

In an example of the first or second embodiment, the machine learning model for defect recognition in the imaging dataset of the wafer is from the group comprising defect detection models, defect classification models, defect localization models, defect segmentation models, anomaly detection models, anomaly classification models, anomaly localization models, anomaly segmentation models.

An anomaly refers to a deviation of a semiconductor structure from an a priori defined norm. A defect, in general, is also an anomaly, but not all anomalies are defects. For example, anomalies can occur due to noise or rare structures in the imaging dataset.

A charged particle beam system includes, but is not limited to, a scanning electron microscope (SEM), a focused ion beam microscope, such as a Helium ion microscope. A further example of a charged particle beam system is a corrected electron scanning microscope, comprising a correction mechanism for correction of chromatic aberration and spherical aberration.

In various embodiments of the disclosure, the embedded system can be a field programmable gate array (FPGA), a digital signal processor (DSP), an arithmetic logic unit (ALU), an application-specific integrated circuit (ASIC), etc.

In various embodiments of the disclosure, the machine learning model for defect recognition in the obtained imaging dataset of the wafer can be from the group comprising defect detection models, defect classification models, defect localization models, defect segmentation models, anomaly detection models, anomaly classification models, anomaly localization models, anomaly segmentation models.

In an example of the second embodiment, the at least one model architecture of the at least one machine learning model for defect recognition comprise a model architecture of a neural network.

According to an aspect of the example of the second embodiment, one or more modules are head modules, a head module being a module comprising an output layer of a neural network.

For example, the one or more head modules can comprise a fully connected output layer of a neural network and/or a convolutional output layer of a neural network.

Furthermore, one or more modules can be tail modules, a tail module being a module comprising a number of hidden layers of a neural network.

In an example, at least one tail module, for example each tail module, comprises all hidden layers of a neural network.

In another example, at least one tail module, in particular each tail module, comprises a number of hidden layers forming a semantic entity. The term “semantic entity” refers to a number of hidden layers that form a functional unit in the sense that they complement each other and together perform a specific function in the neural network.

The subdivision of model architectures into head modules and tail modules strongly reduces the programming effort and the application effort for a user. The head modules comprise the output layer of a neural network and are, thus, task-specific modules. By exchanging a head module by another one, the task of a neural network can be modified, e.g., a defect detection model architecture with a convolutional output layer can become a defect classification model architecture with a fully connected output layer.

The tail modules comprise a number of hidden layers of a neural network. By exchanging a tail module the size of the feature maps of the hidden layers can simply be adapted between small-scale problems and large-scale problems using less or more features to generate satisfying results. Therefore, according to a further aspect of the example of the second embodiment, at least two of the tail modules contain the same number of hidden layers, wherein the sizes of the feature maps of corresponding hidden layers differ by the same factor.

According to a further aspect of the example of the second embodiment, each module of the one or more modules is either a head module, comprising an output layer of a neural network, or a tail module, comprising a number of hidden layers of a neural network.

Head and tail modules can be generated from neural networks by partitioning the neural network into the output layer and one or more sets of hidden layers. The one or more modules can be generated from at least one model architecture of a neural network by partitioning each model architecture into a head module comprising an output layer of the neural network and at least one tail module comprising a number of hidden layers of the neural network. For example, each model architecture of a neural network can be partitioned into a task specific head module and a single tail module allowing for a particularly low effort for specifying the flow of data through the number of modules.

In an example of the second embodiment, the method can further comprise, prior to specifying the flow of data through the number of logic block circuits of the plurality of logic block circuits, determining if the model architecture of the machine learning model can be realized by the plurality of logic block circuits on one of the at least one embedded systems; in response to determining that the model architecture cannot be realized, generating one or more modules of the model architecture of the machine learning model and implementing the one or more modules on one of the at least one embedded systems. In this way, the number of modules and embedded system implemented model architectures grows with the number of use-cases and the system becomes more and more flexible and versatile.

In an example of the first or second embodiment, the model data for the embedded system implemented model architecture is obtained by training a machine learning model comprising the model architecture. In addition or alternatively, the model data for the embedded system implemented model architecture can be loaded from a database. In addition or alternatively, the model data for the embedded system implemented model architecture can also be provided by an external service yielding a new business model. The new business model provides the selling of a system with an embedded system implemented model architecture once and a regular update of the model data as a service, e.g., for improving results of the defect recognition or for adapting the system to a different use-case.

In an example of the first or second embodiment, the model data is transferred to the programmable memory of the embedded system by copying. Alternatively, the model data can be transferred to the programmable memory of the embedded system by replacing the hardware block comprising the programmable memory of the embedded system by a new hardware block comprising the model data to be transferred.

In any of the examples or aspects of the first or second embodiment, for quality assurance or quality control, the recognized defects can be monitored, e.g. in real-time or buffered. To this end, the recognized defects can be directed to a display device or dashboard. In addition or alternatively, the recognized defects can be stored in a long-term memory. In addition or alternatively, the recognized defects can be cached into a memory. The recognized defects can also be analyzed in order to update the embedded system implemented model architecture in step ii).

The third embodiment of the disclosure involves a computer implemented method according to any one of the aspects or examples of the first or second embodiment of the disclosure, further comprising, prior to obtaining an imaging dataset of a wafer in step i), the following steps: iterating the following steps until a convergence criterion is met: selecting at least one image acquisition parameter according to an imaging sampling strategy and acquiring an imaging dataset of a wafer based on the at least one image acquisition parameter; generating training data from the acquired imaging dataset of the wafer; selecting a model architecture and training an associated machine learning model based on the generated training data; determining the quality of the model architecture and the at least one image acquisition parameter by computing an associated objective function value of an objective function evaluating the quality of the trained machine learning model; after the iterations: based on the objective function values, selecting one of the model architectures and the corresponding at least one image acquisition parameter, wherein the imaging dataset of the wafer in step i) is obtained based on the selected at least one image acquisition parameter, and the embedded system implemented model architecture in step ii) comprises the model architecture of the selected machine learning model. In this way, the image acquisition process is optimized with respect to criteria defined by the objective function, e.g., the throughput of the system, the runtime of the defect recognition method or the power consumption of the system.

A fourth embodiment of the disclosure concerns a computer implemented method for defect recognition in an imaging dataset of a wafer, the method comprising: Iterating the following steps until a convergence criterion is met: selecting at least one image acquisition parameter according to an imaging sampling strategy and acquiring an imaging dataset of a wafer based on the at least one image acquisition parameter; generating training data from the acquired imaging dataset of the wafer; selecting a model architecture and training an associated machine learning model based on the generated training data; evaluating the quality of the trained machine learning model by computing an associated objective function value of an objective function; after the final iteration: based on the objective function values, selecting one of the trained machine learning models; applying the selected trained machine learning model to an imaging dataset of a wafer acquired based on the corresponding at least one image acquisition parameter, in order to recognize defects.

According to the third or fourth embodiment, the at least one image acquisition parameter is, for example, from the group comprising imaging time, image resolution, pixel size, landing energy and dwell time of electron waves.

In an example of the third or fourth embodiment the step of selecting a model architecture comprises selecting at least one hyperparameter defining the model architecture of the machine learning model according to an architecture sampling strategy, e.g., using automated machine learning (AutoML) techniques. This procedure is desirable, since the image acquisition process is jointly optimized with the machine learning model hyperparameters with respect to the objective function.

In an example of the third or fourth embodiment, the objective function comprises a measure of complexity of the model architecture. In a further example, the objective function comprises a measure of runtime and/or a measure of throughput and/or a data rate and/or a measure of power consumption. In a further example, the objective function comprises a measure of quality of the defect recognition. In a further example, the objective function comprises a measure of the bit-volume of the input data of the machine learning model. Selecting one or several of these measures in the objective function allows for less complex architectures and, thus, shorter runtimes or higher throughput of the system.

An example of any of the aspects or examples of any of the embodiments further comprises determining one or more measurements of the recognized defects in the imaging dataset of the wafer, in particular size, area, dimension, shape parameters, distance, radius, aspect ratio, type, number of defects, density, spatial distribution of defects, existence of any defects (i.e. if a defect is detected or not) etc. Based on one or more of these measurements, the example can further comprise assessing the quality of the wafer based on the one or more measurements and at least one quality assessment rule. Based on the one or more measurements, the example can comprise controlling at least one wafer manufacturing process parameter based on one or more measurements of the recognized defects in the imaging dataset of the wafer. Wafer manufacturing process parameters include the exposure time, the parameters of etching, deposition, implantation, thermal treatment and other processes involved during manufacturing but are not limited to these parameters. Other defects arise from defects or contamination from various sources, for example degeneration of lithography masks or particle contamination.

The disclosure also involves a computer-readable medium, having stored thereon a computer program executable by a computing device, the computer program comprising code for executing a method according to any of the aspects or examples of the embodiments.

The disclosure also concerns a computer program product comprising instructions which, when the program is executed by a computer, cause the computer to carry out a method according to any of the aspects or examples of the embodiments.

The disclosure also concerns a system for controlling the quality of wafers produced in a semiconductor manufacturing fab, the system comprising: an imaging device adapted to provide an imaging dataset of a wafer; one or more processing devices; optionally, at least one embedded system; one or more machine-readable hardware storage devices comprising instructions that are executable by one or more processing devices to perform operations comprising a method for assessing the quality of a wafer.

The disclosure also involves a system for controlling the production of wafers in a semiconductor manufacturing fab, the system comprising: a mechanism for producing wafers controlled by at least one manufacturing process parameter; an imaging device adapted to provide an imaging dataset of a wafer; one or more processing devices; optionally, an embedded system implementing a model architecture of a machine learning model, or modules thereof, for defect recognition in the imaging dataset of the wafer, the embedded system comprising a programmable memory for transferring model data to the embedded system; one or more machine-readable hardware storage devices comprising instructions that are executable by one or more processing devices to perform operations comprising a method for controlling at least one wafer manufacturing process parameter.

Any of the systems above can comprise a database, a display device and/or a user interface.

While the examples and embodiments of the disclosure are described with respect to semiconductor wafers, it is understood that the disclosure is not limited to semiconductor wafers, but can for example also be applied to reticles or masks for semiconductor fabrication or to other manufactured objects.

The disclosure described by examples and embodiments is not limited to the embodiments and examples but can be implemented by those skilled in the art by various combinations or modifications thereof.

### BRIEF DESCRIPTION OF THE DRAWINGS

FIG. 1 shows schematic cell structures of imaging datasets of three defective wafers;

FIG. 2 shows a flowchart of steps in an exemplary computer implemented method for defect recognition according to a first embodiment of the disclosure;

FIG. 3 illustrates the exploitation of the separation of model architecture and model data for a flexible implementation of a machine learning model into an embedded system;

FIG. 4 shows a flowchart of steps in an exemplary computer implemented method for defect recognition according to a second embodiment of the disclosure;

FIG. 5 illustrates the particularly flexible and versatile method of implementing a machine learning model in a system comprising at least one embedded system;

FIG. 6 illustrates the use of embedded systems in the form of an FPGA for various use-cases based on a separation of hardware related parts and software related parts;

FIG. 7 shows a schematic embedded system implementation of a first module and a second module of a neural network model architecture;

FIG. 8 illustrates a subdivision of a model architecture in the form of a neural network into a head module and a tail module;

FIG. 9 shows different head modules and tail modules of various model architectures;

FIG. 10 shows the process of implementing a new use-case in a system via a computer implemented method according to various embodiments of the disclosure;

FIG. 11 shows a flowchart of steps in an exemplary computer implemented method for defect recognition according to a third embodiment of the disclosure;

FIG. 12 shows a flowchart of steps in an exemplary computer implemented method for defect recognition according to a third embodiment of the disclosure;

FIG. 13 shows a flowchart of steps in an exemplary computer implemented method for defect recognition according to a third embodiment of the disclosure;

FIG. 14 shows a flowchart of steps in an exemplary computer implemented method for defect recognition according to a fourth embodiment of the disclosure;

FIG. 15 illustrates a system, which can be used for controlling the quality of wafers produced in a semiconductor manufacturing fab;

FIG. 16 illustrates a system, which can be used for controlling the production of wafers in a semiconductor manufacturing fab;

FIG. 17 illustrates a system, which can be used for controlling the quality of wafers produced in a semiconductor manufacturing fab; and

FIG. 18 illustrates a system, which can be used for controlling the production of wafers in a semiconductor manufacturing fab.

### DETAILED DESCRIPTION

In the following, exemplary embodiments of the disclosure are described and schematically shown in the figures. Throughout the figures and the description, same reference numbers are used to describe same features or components.

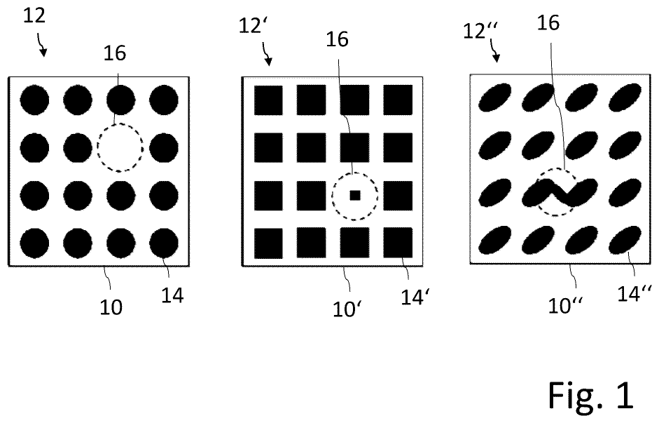

FIG. 1 shows schematic cell structures 10, 10′, 10″ of imaging datasets 12, 12′, 12″ of three defective measurements sites of a wafer 226. In this schematic, the cells 14, 14′, 14″ are identical and regularly distributed over each of the imaging dataset 12, 12′, 12″. The cell structures 10, 10′, 10″ contain defects 16 such as “open”, “dwarf” or “merge”, i.e., deviations of the semiconductor structures from an a priori defined norm. For quality control and quality assurance processes it is desirable to recognize defects 16 in the imaging datasets 12, 12′, 12″ of wafers 226. Quality assurance ensures that the approaches, techniques, methods and processes for wafer manufacturing are implemented according to the desired properties. It aims at improving parameters or conditions of the production process of the wafers in the lab, e.g., deposition, exposure and etching processes. To this end, known and unknown defects is recognized and analyzed. In contrast, quality control aims at ensuring the quality of the final manufactured product in an in-line manufacturing process. To this end, known defects is recognized and analyzed.

For processing huge amounts of data with varying known or unknown defects involving only limited user interaction, machine learning models can be used.

A machine learning model is the result of a machine learning method run on training data. It represents what was learned by the machine learning method. It comprises a model architecture, model data and a prediction method. The model architecture comprises a generalized structure or design of the machine learning model defined by hyperparameters, e.g. the neurons and connections between them of a neural network. The model data contains values, numbers or any other method-specific data structures by which the generalized structure is concretized to solve a specific machine learning problem and to make predictions for new data samples, e.g. the weights of a neural network. The prediction method is a procedure indicating how to use the model data to make predictions on new data, e.g. the forward pass algorithm of a neural network. The application of a machine learning method or a machine learning model to data means the application of the prediction method based on the trained model to the data.

The machine learning models in the various embodiments of the disclosure can be any type of machine learning model, including but not limited to decision tree based models, linear regression based models, neural network based models, Bayesian network based models, support vector machine based models, and nearest neighbor based models, to name a few. The machine learning model provided can also be a combination of different types of models. Moreover, the model can be provided in any type of format. For example, a neural network model can be provided using such typical models as AlexNet, GoogleNet. ResNet, DenseNet, or using another type of neural network format. However, in the various embodiments, the type and format of the model is not limited to those described above. Although the model can be preprocessed and trained in some embodiments, in other embodiments no preprocessing is used. The trained model can also be loaded from one or more files.

For example, a decision tree is a machine learning model comprising a model architecture in the form of a tree of if-then statements. Hyperparameters of model architectures of decision trees define the structure of the tree comprising, for example, the number of tree levels and the number of decision nodes. Decision trees comprise model data in the form of specific values for the if-then-statements, and a prediction method defining the application of the if-then statements to input data.

Support vector machines (SVMs) are machine learning models comprising a model architecture in the form of at least one hyperplane. Hyperparameters of model architectures of SVMs define the at least one hyperplane comprising, for example, the number and format of the hyperplanes. SVMs comprise model data in the form of matrices, vectors or values defining the specific hyperplanes, and a prediction method defining the assignment of output values to input data based on the at least one hyperplane.

Neural networks are machine learning models comprising a model architecture in the form of a graph structure. Hyperparameters of the model architecture of neural networks define the generalized structure or structure of the neural network comprising, for example, the topology and size of the neural network, such as
the type and/or parameters of the loss function
the bottleneck size
the bottleneck filter size (number of features in the bottleneck),
the initial filter size (number of filters in the first layer of the network, the other network features are scaled proportionally to the first layer),
the initial learning rate,
the learning rate decay factor,
utilization of momentum,
the number of epochs,
the regularization scale,
the size and content of the training set (number of images),
the type of convolution used,
the up-sampling scheme,
the connections between the layers,
the number of layers in the model,
samples that represent the dataset,
the size of layers in the model,
the type of layers in the model,
the filter size,
the drop-out rate,
kernel sizes of convolutional layers,
utilization of Nesterov accelerated gradient,
type of optimization algorithm,
etc.

The model data of neural networks comprise the model weights, which comprise vectors or matrices containing specific values defining the transfer function of the neurons of the hidden layers. The transfer function of a neuron transforms input data of the neuron to output data of the neuron, which is then passed to one or more other neurons of the neural network. Transfer functions comprise, for example, sigmoid functions, step functions (thresholds), piecewise linear functions, Gaussian functions or a combination thereof. The prediction method of a neural network defines the forward-pass of input data through the network to obtain a result.

The hyperparameters of model architectures of machine learning models are generally not learned from data. Instead, they can, for example, be selected by an expert or they can be optimized automatically, e.g., using AutoML techniques, in case of neural networks in particular by Neural Architecture Search (NAS) approaches. These techniques automatically search for optimal hyperparameter values of the model architecture of a machine learning model. Based on an objective function evaluating the quality of a set of hyperparameter values, AutoML techniques are usually based on the following iterative principle: prediction of at least one hyperparameter value based on previously selected hyperparameter values and associated values of the objective function; setting up the model architecture of the machine learning model according to the selected hyperparameter values and training the machine learning model based on training data; evaluating the objective function for the predicted at least one hyperparameter based on the trained machine learning model; after the last iteration, selecting the at least one hyperparameter value yielding the best objective function value.

The model data, e.g., the weights of the neural network, in contrast, are learned from training data.

Hyperparameters of the learning algorithm of the machine learning model, in principle, have no influence on the performance of the model architecture but affect the speed and quality of the learning process. Examples of algorithm hyperparameters are learning rate and mini-batch size.

Both processes, quality assurance and quality control, involve defects to be recognized as accurately and as quickly as possible, in order to achieve high throughput or low algorithm runtimes. The throughput of a system can, for example, be measured by the area of a wafer at a given resolution examined within a specific timespan, or by the time used to examine a specific area of a wafer at a given, e.g., 1 cm² of a wafer at 1 nm resolution can be processed in 24 hours.

In order to meet high demands in terms of runtime, embedded systems are often chosen in digital data processing. Yet, the use of embedded systems comes with a high design and setup effort, since pre-programmed libraries, which are common for conventional processors, are not available for programming embedded systems.

In view of such limitations, the various embodiments of the disclosure are directed to new methodologies for implementing machine learning models in embedded systems. The methodologies make use of the above-defined specific structure of machine learning models, comprising a generalized model architecture and use-case specific model data. By implementing only the model architecture of the machine learning model on the embedded system and dynamically loading the learned model data into the programmable memory of the embedded system, the implemented machine learning model architecture can be reused for another use-case or re-trained in case of varying imaging datasets, thereby saving resources, user effort and computation time.

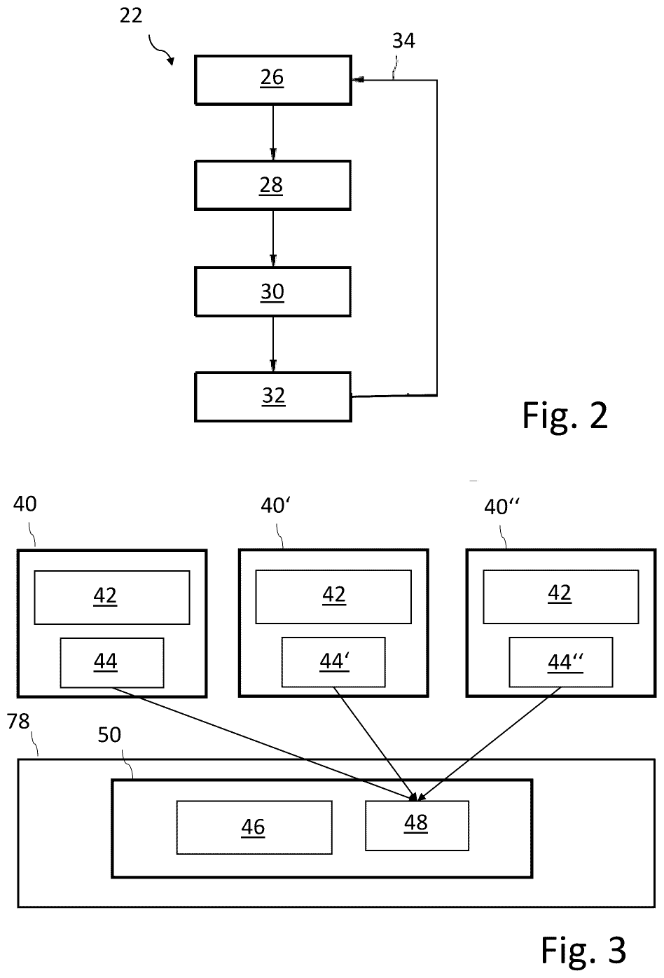

The overall methodology of the first embodiment of the disclosure is illustrated in FIG. 2. FIG. 2 shows a flowchart of steps in an exemplary computer implemented method 22 for defect recognition in an imaging dataset 12, 12′, 12″ of a wafer 226 in a charged particle beam system 78 comprising an embedded system 50, 50′, the method comprising: obtaining an imaging dataset 12, 12′, 12″ of a wafer 226 in an imaging step 26; obtaining model data 44, 44′, 44″ for a model architecture 42 of a machine learning model 40, 40′, 40″ for defect recognition in the imaging dataset 12, 12′, 12″ of the wafer 226, the model architecture 42 being implemented in the embedded system 50, 50′, in a model data step 28; transferring the model data 44, 44′, 44″ to a programmable memory 48, 48′, 48″ of the embedded system 50, 50′ in a model data transfer step 30; applying the machine learning model 40, 40′, 40″ to an imaging dataset 12, 12′, 12″ of a wafer 226 to recognize defects 16, comprising executing the embedded system implemented model architecture 46 with the transferred model data 44, 44′, 44″, in an application step 32. The recognized defects 16 can, for example, be used in a quality assurance system 228, 234 and/or in a quality control system 212, 232, in particular for wafers 226, but also for other manufactured objects. The steps can be repeated in case a new use-case 34 is defined or the model architecture or model data is updated.

FIG. 3 illustrates the exploitation of the separation of model architecture 42 and model data 44, 44′, 44″ for a flexible implementation of a machine learning model 40, 40′, 40″ in an embedded system 50. Three machine learning models 40, 40′, 40″ comprising the same model architecture 42 but different model data 44, 44′, 44″, e.g. a neural network with three different sets of weights for three different use-cases, can be implemented into an embedded system 50 by implementing the model architecture 42 in the embedded system 50 yielding an embedded system implemented model architecture 46, and by transferring the respective model data 44, 44′, 44″ into a programmable memory 48 of the embedded system 50. In this way, different use-cases can easily be implemented into an embedded system 50. Also, an adaptation or improvement of the model data 44 of a machine learning model 40 is easily possible. For example, when improved model data 44′, 44″ is available, e.g. by retraining the machine learning model 40, or when desired properties of the machine learning model 40 change, e.g. when unknown defects occur in the imaging dataset 12, 12′, 12″ and the machine learning model 40 has to be retrained, the new model data 44′, 44″ can easily be transferred to the programmable memory 48 of the embedded system 50, saving implementation effort and time while increasing throughput and decreasing runtime due to the embedded system implementation of the machine learning model 40.

In an example, a wafer 226 comprises different measurement sites with different semiconductor structures to be investigated. Using the method according to the first embodiment, it is possible to quickly switch during the inspection of a wafer 226 from a first defect inspection task of a first imaging dataset 12 obtained at a first measurement site to a second defect inspection task of a second imaging dataset 12′ obtained at a second measurement site of a wafer 226. During the inspection of a wafer 226, first predefined model data 44 are obtained from a memory of a charged particle beam system 78 and transferred to the programmable memory 48 of the embedded system 50 for execution of the first defect inspection task. During the inspection of a wafer 226, second predefined model data 44′ are obtained from a memory of the charged particle beam system 78 and transferred to the programmable memory 48 of the embedded system 50 for execution of the second defect inspection task. In an example, a third defect inspection task of a third imaging dataset 12″ obtained at a third measurement site of a wafer 226 is added to the inspection of a wafer 226. For the third defect inspection task, third model data 44″ is determined for the model architecture 42 implemented in the embedded system 50. An example for a determination of third model data 44″ for a new defect inspection task is described further below in the third embodiment. The newly determined third model data 44″ is stored in the memory of the charged particle beam system 78 and transferred to the programmable memory 48 of the embedded system 50 for execution of the third defect inspection task. The model data 44, 44′, 44″ is stored in the memory of the charged particle beam system 78 and is associated with different defect inspection tasks corresponding to different imaging dataset 12, 12′, 12″ obtained by the charged particle beam system 78 at different measurement sites of a wafer 226.

The flexibility and modularity of the method can be even further increased by subdividing a model architecture into a number of FPGA implemented modules, which can be combined to form different types of machine learning architectures.

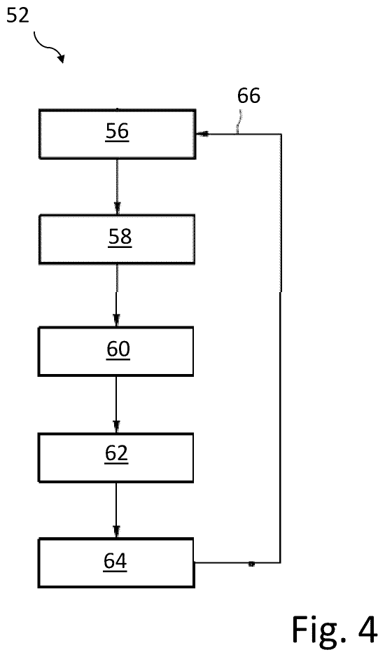

The overall methodology of the second embodiment of the disclosure is illustrated in FIG. 4. FIG. 4 shows a flowchart of steps in an exemplary computer implemented method 52 for defect recognition in an imaging dataset 12, 12′, 12″ of a wafer 226 in a charged particle beam system 78 comprising at least one embedded system 50, 50′, the method comprising: obtaining an imaging dataset 12, 12′, 12″ of a wafer 226 in an imaging step 56; defining an embedded system implemented model architecture 46 of a machine learning model 40, 40′, 40″ for defect recognition in the imaging dataset 12, 12′, 12″ of the wafer 226 by specifying a flow of data 74 through a number of logic block circuits 72′, 72′″ of a plurality of logic block circuits 72, 72′, 72″, 72′″, 74, 74′, 74″, 74′″ on one of the at least one embedded systems 50, 50′, wherein the plurality of logic block circuits 72, 72′, 72″, 72′″, 74, 74′, 74″, 74′″ comprise one or more modules 102, 104 of at least one model architecture 42 of at least one machine learning model 40, 40′, 40″ for defect recognition, in a data flow specification step 58; obtaining model data 44, 44′, 44″ for the embedded system implemented model architecture 46 in a model data step 60; transferring the model data 44, 44′, 44″ to a programmable memory 48, 48′, 48″ of the embedded system 50, 50′ in a model data transfer step 62; applying the machine learning model 40, 40′, 40″ to the imaging dataset 12, 12′, 12″ of a wafer 226 to recognize defects 16, comprising executing the embedded system implemented model architecture 46 with the transferred model data 44, 44′, 44″ in an application step 64. The recognized defects 16 can, for example, be used in a quality assurance system 115 and/or in a quality control system 117, in particular for wafers 226, but also for other manufactured objects. The steps can be repeated in case a new use-case 66 is defined or the model architecture or model data is updated.

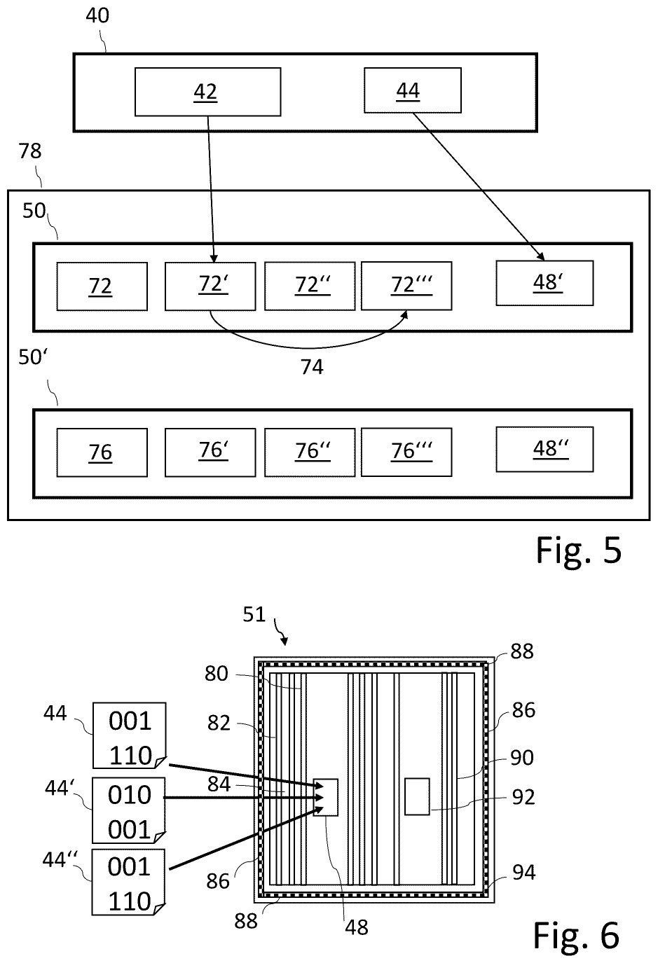

FIG. 5 illustrates the particularly flexible and versatile approach of implementing a machine learning model 40 in a charged particle beam system 78 comprising two embedded systems 50, 50′. The embedded systems 50, 50′ comprise modules of different model architectures, which are implemented each by a plurality of logic block circuits 72, 72′, 72″, 72′″, 74, 74′, 74″, 74′″. In order to implement a specific model architecture 42 in the charged particle beam system 78, a number of logic block circuits 72′, 72′″ in one of the embedded systems 50 is selected and a flow of data 74 is specified by interconnecting the selected number of logic block circuits 72′, 72′″ in the embedded system 50. The model data 44 can be transferred to the programmable memory 48′ of the embedded system 50 as described above. In this way, the effort of implementing machine learning models in charged particle beam systems 78 comprising embedded systems 50, 50′ is reduced, since not only different model data 44, 44′, 44″, but also different model architectures 42 comprising various modules can easily be implemented by interconnecting the number of logic block circuits 72′, 72′″ corresponding to the modules of the model architectures 42. Due to the modular nature of machine learning models combined with the dynamic reconfiguration possibilities offered by embedded systems, the objectives described above can be obtained.

Whenever a new use-case 34, 66 occurs, the machine learning model 40 can be retrained and the new model data 44′, 44″ can be transferred into a programmable memory 48, 48′, 48″ of an embedded system 50, 50′ without modifying the embedded system implemented model architecture 46. Due to the separation into the embedded system implementation of the model architecture 42 and the generation and transfer of model data 40, 40′, 40″ into a programmable memory 48, 48′, 48″ of the embedded system 50, 50′, the considerable time and effort used for implementing machine learning models 40 on an embedded system 50, 50′ is eased, since the model data 44, 44′, 44″ can easily be exchanged in case of a new use-case 34, 66. In this way, embedded system programs for machine learning are made more flexible, reusable and versatile. At the same time, new business models are enabled, where the charged particle beam system including the at least one embedded system 50, 50′ comprising the implemented model architecture 46 respectively the plurality of logic block circuits 72, 72′, 72″, 72′″, 74, 74′, 74″, 74′″ implementing modules of machine learning architectures is sold to the customer only once, whereas the model data 44, 44′, 44″ can be updated, e.g. on a regular basis via a service contract or whenever the use-case or desired properties change.

FIG. 6 illustrates the use of embedded systems 50, 50′ in the form of an FPGA 51 for various use-cases. An FPGA is an integrated circuit designed to be configured by a customer or a designer after manufacturing. The FPGA configuration is generally specified using a hardware description language. FPGAs contain an array of programmable logic blocks, and a hierarchy of reconfigurable interconnects allowing blocks to be wired together. Logic blocks can be configured to perform complex combinational functions, or act as simple logic gates like AND and XOR. In most FPGAs, logic blocks also include memory elements, which may be simple flip-flops or more complete blocks of memory. Many FPGAs can be reprogrammed to implement different logic functions, allowing flexible reconfigurable computing. The FPGA 51 comprises adaptive logic modules 80, an M512 block 82, an M4K block 84, high-speed I/O channels with dynamic phase alignment (DPA) 86, I/O channels with external memory interface circuitry 88, digital signal processing blocks 90, M-RAM blocks 92 and phase locked loops 94. By only exchanging the model data 44, 44′, 44″ in the programmable memory 48 of the FPGA 51, a new use-case can be realized in the same charged particle beam system 78 without any additional effort of reprogramming the FPGA 51.

The model data 44, 44′, 44″ for the FPGA implemented model architecture 46 can be obtained in different ways. For example, the model data 44, 44′, 44″ for the FPGA implemented model architecture 46 can be loaded from a database 225. The model data 44, 44′, 44″ for the FPGA implemented model architecture 46 can also be obtained by training a machine learning model 40, 40′, 40″ comprising the model architecture 46. After training, the obtained model data 44, 44′, 44″ can be saved into a database 225 to make it available to further applications. Furthermore, the model data 44, 44′, 44″ can be provided by an external service allowing for a dynamic update of the model data 44, 44′, 44″, e.g., for improvement or for adaptation of the model data 44, 44′, 44″ to modified desired properties. Such a service can be used as a new business model separating the hardware comprising the embedded system with the implemented model architecture respectively the modules, which is only sold once, from the model data, which can be updated on a regular basis. In this way, time and effort can be saved, a high flexibility of the systems can be achieved, the quality of the defect recognition methods can be optimized and at the same time the throughput is maximized, and the runtime decreased due to the use of embedded systems 50, 50′ for implementing the machine learning models 40, 40′, 40″.

In an example of the first or second embodiment of the disclosure, the model data 44, 44′, 44″ can be transferred to the programmable memory 48, 48′, 48″ of the embedded system 50, 50′ by copying. Alternatively, the model data 44, 44′, 44″ can be transferred to the programmable memory 48, 48′, 48″ of the embedded system 50, 50′ by replacing the hardware block comprising the programmable memory 48, 48′, 48″ of the embedded system 50, 50′ by a new hardware block comprising the model data 44, 44′, 44″ to be transferred.

In order to provide defect recognition results to a user for quality assessment or quality control, the recognized defects 16 can, for example, be directed to a display device 227 or dashboard, allowing for real-time monitoring of the detected defects 16. In another example of the first or second embodiment, the recognized defects 16 can be stored in a long-term memory for further analysis, e.g., for generating statistics over defects 16. In a further example, the recognized defects in can be cached into a memory for a specified timespan, e.g., for 48 hours to allow for a further analysis of the detected defects 16 but without involving a lot of memory. In another example, the recognized defects in are analyzed in order to update the embedded system implemented model architecture 46 in step ii), e.g., the defect recognition results are used to receive feedback from downstream applications followed by an update of the embedded system implemented model architecture respectively modules, for example to address data drift.

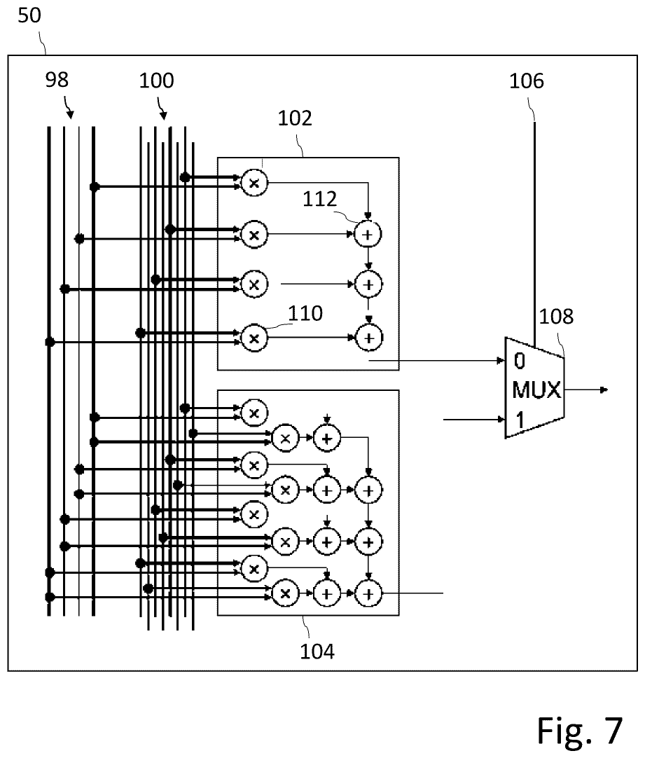

The charged particle beam system 78 in the second embodiment of the disclosure comprises at least one embedded system 50, 50′ to allow for the implementation of different machine learning models 40, 40′, 40″ based on different model architectures 42 in the same charged particle beam system 78. Each model architecture can be implemented into a separate embedded system 50, 50′ in the charged particle beam system 78. Different model architectures 42 can also be implemented into the same embedded system 50, 50′. In order to make the system more flexible and versatile, model architectures 42 of machine learning models 40, 40′, 40″ can be partitioned into one or more modules and implemented in a plurality of logic block circuits 72, 72′, 72″, 72′″, 74, 74′, 74″, 74′″ in one or more of the at least one embedded system 50, 50′. In this way, during application of the defect recognition method, new model architectures 42 of machine learning models 40, 40′, 40″ can easily be implemented in the charged particle beam system 78 by specifying a flow of data 74 through the used number of logic block circuits 72′, 72′″ and interconnecting the logic block circuits 72′, 72′″ as shown in and described with respect to FIG. 7.

FIG. 7 shows a schematic embedded system implementation of a first module 102 and a second module 104 of a neural network model architecture. The input data for both modules 102, 104 is available via the input data bus 98. The model data in the form of weights 100 for each module 102, 104 are available via the programmable memory 48 on the embedded system 50. The first module 102 has one convolutional layer with a single 2×2 filter based on multiplications 110 of the input data on the input data bus 98 with the weights 100 corresponding to the first module 102. The second module 104 has two convolutional 2×2 filters based on multiplications 110 of the input data on the input data bus 98 with the weights 100 corresponding to the second module 104. When defining the flow of data 74, a module 102, 104 can be selected using the multiplexer 108, which is configured via programmable configure memory 106, e.g., by the user.

The modules of the model architectures can comprise parts of the model architectures, e.g., one or more layers of a neural network, a subtree of a decision tree, one or more hyperplanes of an SVM, a set of one or more nodes of a graph structure, e.g., in a Hidden Markov Model, etc.

According to an example of the second embodiment, at least one model architecture of the at least one machine learning model for defect recognition comprises a model architecture of a neural network, e.g., for deep learning. This means that neural networks can be particularly suitable for subdivision into logic block circuits due to the subdivision into layers, which reduces the effort for programming the embedded system and specifying the flow of data through the logic block circuits.

According to an aspect of the example of the second embodiment, one or more modules can be head modules, a head module being a module comprising an output layer of a neural network. The output layer generates the result of the neural network when presented with input data, e.g., a classification into one of a number of classes, a binary output, or one or more specific return values, etc. The output layer is task specific, i.e. it can only be used for specific tasks. The one or more head modules can, for example, comprise a fully connected output layer of a neural network and/or a convolutional output layer of a neural network. The fully connected output layer of a neural network is, for example, specifically designed for the task of classification, since there is no limitation of the spatial context in the output layer. The convolutional layer of a neural network is, for example, specifically designed for the task of defect detection, anomaly detection or defect segmentation due to the consideration of the spatial context.

According to an aspect of the example of the second embodiment, one or more modules are tail modules, a tail module being a module comprising a number of hidden layers of a neural network. This allows for a combination of several hidden layers into a single tail module, thereby reducing the programming effort and the effort during specification of the flow of data.

The separation of head and/or tail modules offers flexibility and versatility, since the task the neural network is put to can easily be modified by exchanging the head module in order to modify the flow of data, and since the tail modules can be used in many different model architectures without additional effort.

In addition, the subdivision of a model architecture into head and tail modules allows for a semantic combination of hidden layers fulfil a specific task within the model architecture into a single tail module. In this way, the modular structure of the model architectures is further simplified reducing the programming effort and the effort for specifying the flow of data.

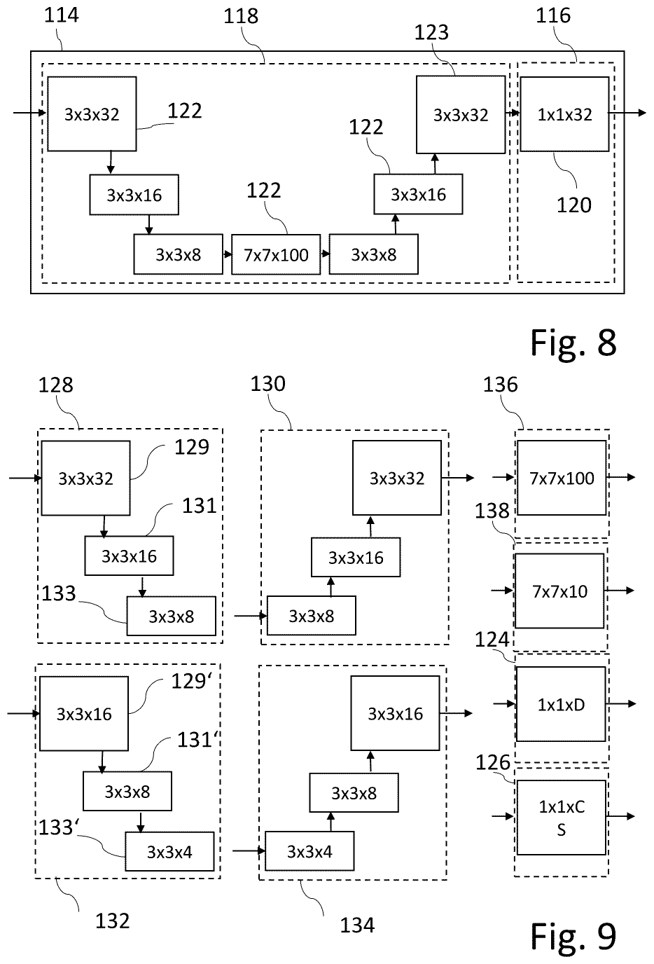

For example, FIG. 8 illustrates a subdivision of a model architecture 42 in the form of a neural network 114 into a head module 116 and a tail module 118. FIG. 8 shows a neural network 114 comprising hidden layers 122, 123 and an output layer 120 obtained with filters of indicated spatial and feature sizes. The neural network 114 contains a head module 116 comprising the output layer 120 of the neural network 114 and a single tail module 118. The head module 116 comprises the output layer 120 of the neural network 114, whereas the tail module 118 comprises a number of hidden layers 122, 123 of the neural network 114, in particular all hidden layers 122, 123. The output layer is a 1×1×32 filter-wise pooling layer and is, therefore, adapted to solve a defect detection or anomaly detection or segmentation task based on a feature map comprising 32 features generated by the final hidden layer 123. The separation of the task specific head module 116 from the remaining model architecture is beneficial, since in this way the head module 116 can easily be exchanged for a different head module 116, in order to put the model architecture to a different task in a different application. For example, the head module 116 can be adapted to a classification task.

FIG. 9 shows different head modules 124, 126 and tail modules 128, 130, 132, 134, 136, 138 of various model architectures. Due to this modular structure, a family of model architectures can be realized on an embedded system 50, 50′ by combining one or more different tail modules 128, 130, 132, 134, 136, 138 with one of the head modules 124, 126. The head modules 124, 126 can be task specific. For example, the head module 124 of filter size 1×1×D, D indicating the number of features, is, for example, suitable for anomaly detection, defect detection or segmentation tasks, whereas the head module 126 of filter size 1×1×C S, S meaning softmax, with C indicating the number of classes, is suitable for classification tasks. This modularity means that the task of the neural network can easily be modified by simply exchanging the head module 124, 126, e.g., the output layer of the neural network, without modifying the tail modules 128, 130, 132, 134, 136, 138, e.g., the hidden layers of the neural network, which define the flow of data 74 for realizing the model architecture on an embedded system 50, 50′.

According to another aspect of the example of the second embodiment, at least one tail module, in particular each tail module, can comprise all hidden layers 122, 123 of a neural network 114 as shown in FIG. 8. This is beneficial, since each neural network 114 only consists of a single head module 116 and a single tail module 118. This allows for a particularly simple embedded system implementation of the neural network and a particularly simple specification of the flow of data through the logic block circuits of the embedded system, since fewer blocks have to be interconnected.

According to a further aspect of the example of the second embodiment, at least one tail module, in particular each tail module, can comprise a number of hidden layers of a neural network forming a semantic entity. The term “semantic entity” refers to a number of hidden layers 122, 123 that form a functional unit in the sense that they complement each other and together perform a specific function in the neural network 114. For example, the hidden layers of tail module 128 are a semantic entity, since they form a functional unit for downscaling the input data. The same accounts for the hidden layers of tail module 132. The hidden layer of tail module 136 forms a functional entity, since it forms a bottleneck for decreasing the dimensionality of the data, e.g. for representing an autoencoder. The same accounts for the hidden layer of tail module 138. The hidden layers of tail module 130 are a semantic entity, since they form a functional unit for upscaling the data. The same accounts for the hidden layers of tail module 134. By defining tail modules forming semantic entities the effort for implementing model architectures on the one or more embedded systems is decreased, since only a few functional entities performing specific functions in the model architecture have to be interconnected for specifying the flow of data.

According to a further aspect of the example of the second embodiment, at least two of the tail modules contain the same number of hidden layers, wherein the sizes of the feature maps of corresponding hidden layers differ by the same factor. Hidden layers of two modules correspond to each other in terms of their rank in the order of hidden layers of the module, e.g., the second hidden layer of a module corresponds to the second hidden layer of another module. This allows for the implementation of neural networks considering different numbers of features, e.g., using small, medium or large modules, for the same task. In a further aspect of the example of the second embodiment, for each tail module at least one other tail module exists containing the same number of hidden layers, wherein the sizes of the feature maps of corresponding hidden layers differ by the same factor. FIG. 9, for example, shows two tail modules 128, 132 comprising the same number of hidden layers, namely three. The size of the feature maps of the corresponding first layers 129, 129′ is 32 respectively 16 differing by a factor of 2. The size of the feature maps of the corresponding second layers 131, 131′ is 16 respectively 8 differing by a factor of 2. The size of the feature maps of the corresponding third layers 133, 133′ is 8 respectively 4 also differing by a factor of 2. The modules 128 and 132, thus, fulfill the same task and only differ in the complexity of their feature maps. The tail modules 136 and 138, for example, only contain a single corresponding hidden layer, wherein the size of the feature maps differs by a factor of 10. In this way, model architectures considering different amounts of features, e.g. small-scale, medium-scale or large-scale model architectures, can be implemented in the same embedded system in order to allow for an adaptation of the size of the model architecture to the difficulty of the machine learning task. A model architecture with more or less features can easily be implemented on the embedded system by exchanging the corresponding logic block circuits of a small-size tail module 138 for the logic block circuits of a large-size tail module 136. In this way, the embedded system implementation of model architectures becomes particularly flexible and adaptable to the desired properties of the machine learning task to be solved.

In FIG. 9, for example, anomaly or defect detection based on a larger U-net model architecture considering a larger number of features can be carried out by specifying the flow of data interconnecting tail modules 128, 136 and 130 with head module 124. Here, tail module 128 downscales the input data, tail module 136 represents the bottleneck used to obtain a representation of the input data of very low dimensionality, and tail module 130 upscales the data, so the combination of these tail modules 128, 136, 130 represents the structure of an autoencoder. The head module 124 represents a convolutional layer for computing the result of the defect or anomaly detection task. Such large-size model architectures are useful for more complicated defect or anomaly detection tasks involving more features to be taken into account. To carry out anomaly or defect detection based on a smaller U-net model architecture considering a small number of features only, tail modules 132, 138 and 134 can be interconnected with head module 124. The combination of the tail modules 132, 138 and 134 also represents an autoencoder, but with less features and smaller bottleneck. The head module 124 represents a convolutional layer for computing the result of the defect or anomaly detection task. Such small-size model architectures are useful for less complicated defect or anomaly detection tasks involving fewer features to be taken into account.

The modular structure shown in FIG. 9 can also be used for segmentation tasks. Here, a large-size U-net model architecture can be implemented on the embedded system by interconnecting tail module 128 with head module 124. To obtain a small-size U-net model architecture on the embedded system, tail module 132 can be interconnected with head module 124. Head module 124 is a convolutional layer used to compute the result of the segmentation task, i.e., the assignment of each pixel of the imaging dataset to a specific class. Depending on the difficulty of the segmentation task, a larger or a smaller number of features should be considered and, therefore, a large-size model architecture or, respectively, a small-size architecture is useful.

The modular structure shown in FIG. 9 can also be used for classification tasks. Classification based on a larger U-net model architecture considering a larger number of features can be carried out by specifying the flow of data interconnecting tail modules 128, 136 and 130 with head module 126. Again, the combination of these tail modules 128, 136, 130 represents the structure of an autoencoder. The head module 126 represents a fully connected softmax layer for computing the result of the classification task. Such large-size model architectures are useful for more complicated classification tasks involving more features to be taken into account. To carry out classification based on a smaller U-net model architecture considering a small number of features only, tail modules 132, 138 and 134 can be interconnected with head module 126. The combination of the tail modules 132, 138 and 134 also represents an autoencoder, but with less features and smaller bottleneck. The head module 126 represents a fully connected layer for computing the result of the classification task. Such small-size model architectures are useful for less complicated classification tasks involving fewer features to be taken into account.

In this way, large-size, medium-size or small-size model architectures can easily be implemented on embedded systems making the system highly flexible for varying desired properties of different tasks. In addition, testing different model architectures during quality assurance in order to find the best model architecture in terms of quality and runtime is simplified due to the modular implementation of model architectures with different feature map sizes on embedded systems.

According to an aspect of the example of the second embodiment, each module of the one or more modules is either a head module, comprising an output layer of a neural network, or a tail module, comprising a number of hidden layers of a neural network. In addition, the one or more modules can comprise at least one head module and at least one tail module.

According to an aspect of the example of the second embodiment, the one or more modules are generated from at least one model architecture of a neural network by partitioning each model architecture into a head module comprising an output layer of the neural network and at least one, in particular a single, tail module comprising a number of hidden layers of the neural network. In this way, the modules implemented on the at least one embedded system in the charged particle beam system directly correspond to model architectures comprising all hidden layers of neural networks, so these neural networks can easily be implemented in the system.

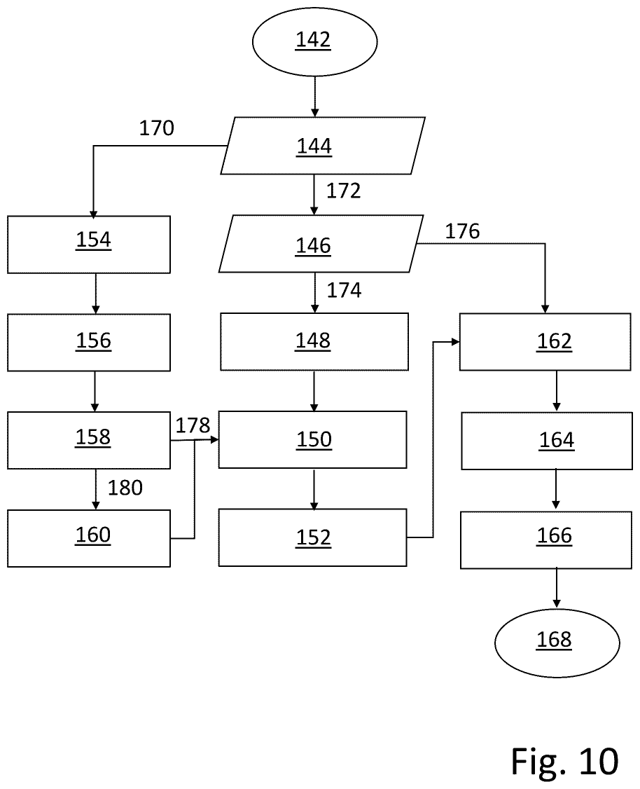

According to the second embodiment of the disclosure, prior to specifying the flow of data through the number of logic block circuits of the plurality of logic block circuits, it is desirable to determine if the model architecture of the trained machine learning model can be realized by the plurality of logic block circuits on one of the at least one embedded systems, and, in response to determining that the model architecture cannot be realized, generating one or more modules of the model architecture of the trained machine learning model and implementing the one or more modules on one of the at least one embedded systems. In this way, it can be checked for a given machine learning task and corresponding machine learning model, if the model architecture of the machine learning model can be realized by the different modules already implemented in the embedded systems of the charged particle beam system. If this is not the case, the missing modules can be determined and implemented into one of the embedded systems of the charged particle beam system, in order to make the model architecture representable by the logic block circuits of the embedded system in the charged particle beam system. This process is illustrated in FIG. 10.

FIG. 10 shows the process of implementing a new use-case 34, 66 in a charged particle beam system 78 via a computer implemented method according to one or more embodiments or examples of the disclosure. After start 142, the family of machine learning models used to solve the new use-case 34, 66 is determined in a family decision step 144. A family can, for example, comprise defect detection models, segmentation models or classification models. If the use-case belongs to a new family not yet implemented in the system (yes 170) the expert collects information about possible use-cases of this family in a use-case collection step 154. The expert defines a generic model architecture for this family, which includes the determined possible use-cases in a model architecture definition step 156. The expert then determines if the defined model architecture is realizable on an existing embedded system in the charged particle beam system 78 in a realizability step 158. If this is not the case (no 180) the defined model is generalized on a new embedded system in the charged particle beam system 78 in a model implementation step 160. Otherwise (yes 178), in a data acquisition and training step 150, training data and groundtruth data is acquired and the machine learning model for the new use-case 34, 66 is trained. The expert saves the generated model data, e.g., the weights of a neural network, to a database in a model data saving step 152. In order to run the machine learning model on an embedded system in the charged particle beam system 78, the pretrained model data is loaded from the database in a model data lookup step 162. In a model data transfer step 164, the determined model data is downloaded from the database and transferred into the programmable memory of an embedded system, which can realize the model architecture of the machine learning model for the new use-case 34, 66 in the charged particle beam system 78. Finally, the machine learning model implemented in the embedded system is run on input data in real-time in a data processing step 166, before the process stops 168. If, otherwise, the use-case belongs to a new family already implemented in the system (no 172), it is determined if the use-case is a new use-case 34, 66 not yet implemented in the system (yes 174) or not (no 176). In case the use-case is a new use-case 34, 66, the model architecture of the family is already implemented in the system, but the model data is generated for the new use-case 34, 66. Therefore, the machine learning problem is cast onto a predefined model architecture of the family already implemented in the system in a problem casting step 148. Then, the model data is obtained as described above in the data acquisition and training step 150 and the process continues as described above. If, on the other hand, the use-case is already implemented in the system (no 176), the model architecture as well as the model data is already available and the process continues with the model data lookup step 162 as described above.

As shown above, the implementation of model architectures of machine learning models on embedded systems based on tail modules and task specific head modules, which can be interconnected to form a flow of data through the plurality of logic block circuits on the embedded system, in combination with easily exchangeable model data in a programmable memory of the embedded system yields a highly flexible, adaptable and versatile implementation of machine learning models on embedded systems.

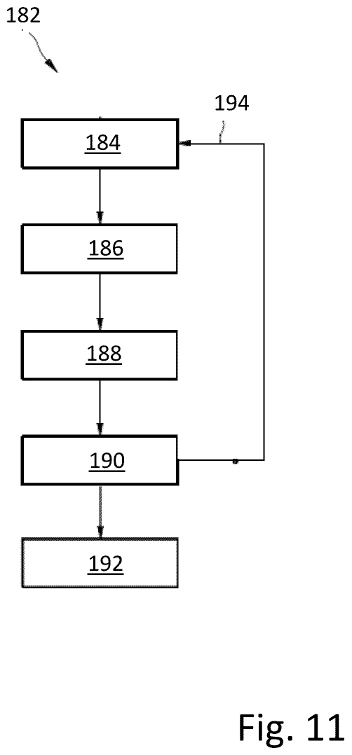

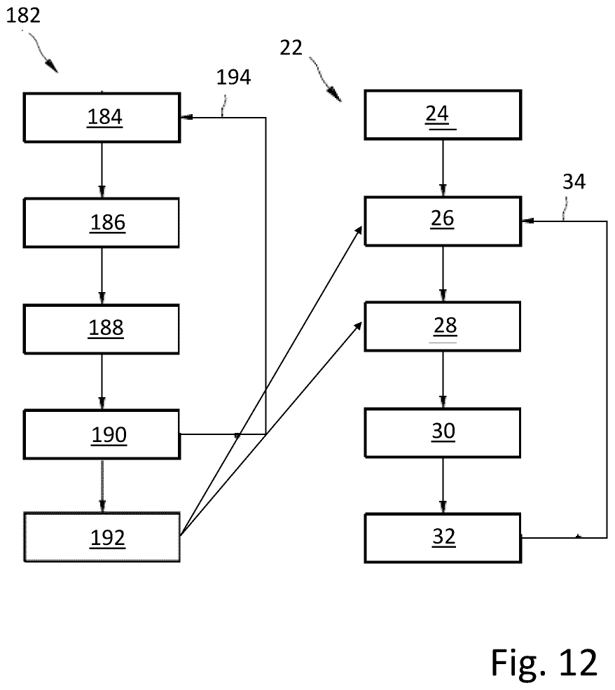

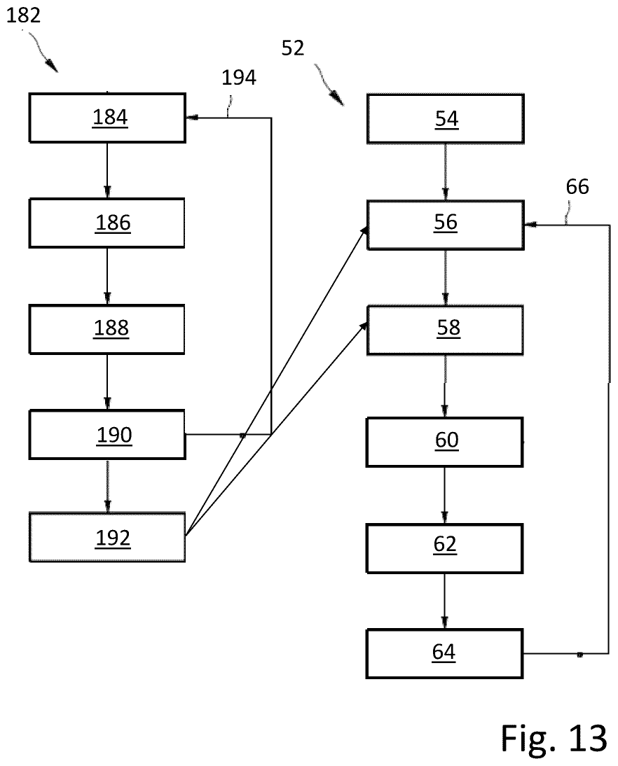

A third embodiment of the disclosure is described in the following with reference to FIG. 11. FIG. 11 shows a flowchart of steps in an exemplary computer implemented method 182 for defect recognition. The method comprises the computer implemented method 22, 52 according to the first or second embodiment of the disclosure or to any example or aspect thereof, further comprising, prior to obtaining an imaging dataset of a wafer in step i) an iteration 194 of the following steps until a convergence criterion, e.g. a maximum number of steps, is met: selecting at least one image acquisition parameter according to an imaging sampling strategy and acquiring an imaging dataset of a wafer based on the at least one image acquisition parameter in an image acquisition parameter step 184; generating training data from the acquired imaging dataset of the wafer in a training data generation step 186; selecting a model architecture and training an associated machine learning model based on the generated training data in a machine learning model training step 188; determining the quality of the model architecture and the at least one image acquisition parameter by computing an associated objective function value of an objective function evaluating the quality of the trained machine learning model in a quality evaluation step 190; after the final iteration 194: based on the objective function values, selecting one of the model architectures and the corresponding at least one image acquisition parameter in a selection step 192. The imaging dataset of the wafer in step i) 26, 56 of the computer implemented method according to the first or second embodiment of the disclosure or to any example or aspect thereof is obtained based on the selected at least one image acquisition parameter, and the embedded system implemented model architecture in step ii) 28, 58 of the computer implemented method according to the first or second embodiment of the disclosure or to any example or aspect thereof comprises the model architecture of the selected machine learning model. This aspect is illustrated in FIGS. 12 and 13, where the model architecture and the corresponding at least one image acquisition parameter selected in the selection step 192 are used in steps 26, 28, 56, 58 of the computer implemented methods 22, 52.

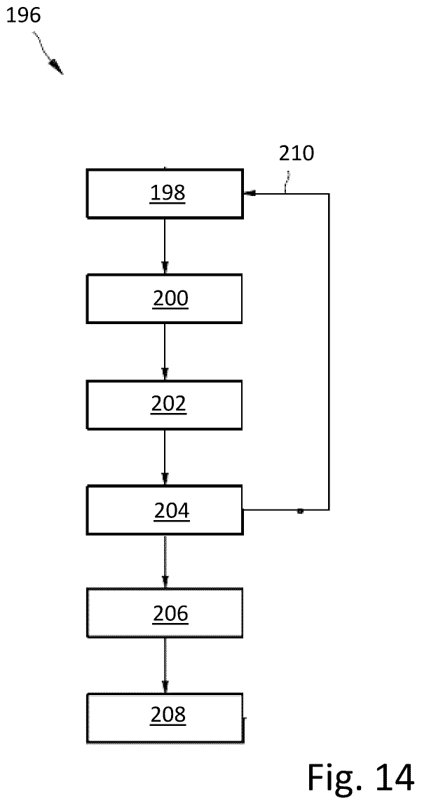

A fourth embodiment of the disclosure is described in the following with reference to FIG. 14. The fourth embodiment of the disclosure is a computer implemented method 196 for defect recognition in an imaging dataset of a wafer, the method comprising: an iteration 210 of the following steps until a convergence criterion, e.g. a maximum number of steps, is met: selecting at least one image acquisition parameter according to an imaging sampling strategy and acquiring an imaging dataset of a wafer based on the at least one image acquisition parameter in an image acquisition parameter step 198; generating training data from the acquired imaging dataset of the wafer in a training data generation step 200; selecting a model architecture and training an associated machine learning model based on the generated training data in a machine learning model training step 202; evaluating the quality of the trained machine learning model by computing an associated objective function value of an objective function in a quality evaluation step 204; after the final iteration 210: based on the objective function values, selecting one of the trained machine learning models in a selection step 206; applying the selected trained machine learning model to an imaging dataset of a wafer acquired based on the corresponding at least one image acquisition parameter, in order to recognize defects in an application step 208. The recognized defects can be used in a quality assurance and/or a quality control system for wafers.

Methods according to the third or fourth embodiment of the disclosure are implementable such that the at least one image acquisition parameter used for generating the imaging dataset of the wafer and, thus, the training data, and the model architecture of the machine learning model can be optimized jointly, before implementing the model architecture on one of the embedded systems in the charged particle beam system. In this process, the model architecture can be optimized with respect to different criteria, e.g., to reduce the runtime, to further increase the throughput of the charged particle beam system, to reduce the complexity of the model architecture or to improve the quality of the predictions of the machine learning model.

The at least one image acquisition parameter can, for example, stem from the group comprising imaging time, image resolution, pixel size, landing energy and dwell time of electron waves.

In an example of the third or fourth embodiment of the disclosure the step of selecting a model architecture 42 comprises selecting at least one hyperparameter defining the model architecture 42 of the machine learning model 40, 40′, 40″ according to an architecture sampling strategy. An architecture sampling strategy can comprise a number of hyperparameters selected by a user, or automatically sampled hyperparameters, e.g., according to AutoML techniques and sampling strategies for hyperparameters known to the person skilled in the art, for example a tree structured Parzen estimator or the asynchronous successive halvings strategy. This is beneficial, since the hyperparameters of the machine learning model can be optimized automatically jointly with the at least one image acquisition parameter.

In an example of the third or fourth embodiment of the disclosure, the objective function can comprise a measure of complexity of the model architecture 42. A measure of complexity can, for example, comprise the size of the model architecture 42, e.g., the number of layers and/or the number of neurons of a neural network 114, the number of hyperplanes of an SVM, the number of levels and/or nodes of a decision tree or the number of nodes and connections in a graph structure. A measure of complexity means that model architectures 42 of smaller size can be used to solve the machine learning task, thereby reducing the runtime of the machine learning model 40, 40′, 40″, increasing the throughput of the charged particle beam system 78 and involving less space on an embedded system 50, 50′, so more model architectures 42 can be implemented in the embedded systems 50, 50′ in the charged particle beam system 78.

In another example of the third or fourth embodiment of the disclosure, the objective function can comprise a measure of runtime and/or a measure of throughput and/or a data rate and/or a measure of power consumption.

In another example of the third or fourth embodiment of the disclosure, the objective function can comprise a measure of quality of the defect recognition, for example a loss function of a neural network 114 applied to training data, or any other measurement known to a person skilled in the art for measuring the prediction error of the machine learning model 40, 40′, 40″ on the training data generated via the at least one image acquisition parameter.

In a further example of the third or fourth embodiment of the disclosure, the objective function can comprise a measure of the bit-volume of the input data of the machine learning model 40, 40′, 40″, for example the number of input bits of the input layer of the machine learning model 40, 40′, 40″. In this way, the complexity of the model architecture 42 can be reduced. This allows for reduced runtimes of the machine learning model 40, 40′, 40″ due to less data having to be processed. Furthermore, model architectures 42 with reduced input bit-volume can be more easily implemented on embedded systems 50, 50′ due to the reduced space used. In this way, more different model architectures 42 can be implemented on the embedded systems 50, 50′ of the charged particle beam system 78. In case of a very large model architecture 42 not fit for implementation on an embedded system 50, 50′ the size of the model architecture 42 can be reduced by reducing the input bit-volume, thereby increasing the chances of being able to implement the machine learning model 40, 40′, 40″ on the embedded system 50, 50′.

In an example of one of the embodiments of the disclosure the computer implemented method further comprises determining one or more measurements of the recognized defects in the imaging dataset of the wafer, in particular size, area, dimension, shape parameters, distance, radius, aspect ratio, type, number of defects, density, spatial distribution of defects. The measurements can be computed for a specific region, e.g., for user defined masks, die-borders or die-cores, etc., or the whole imaging dataset. The quality of the wafer can be assessed based on the one or more measurements and at least one quality assessment rule, e.g., according to a DIN-ISO quality specification, which defines the upper limits for acceptability of non-ideal wafers. For example, the density of a specific defect type at die-cores should be lower than 10 per nm².

According to any one of the embodiments of the disclosure, at least one wafer manufacturing process parameter can be controlled based on the one or more measurements of the recognized defects in the imaging dataset of the wafer.

The disclosure also relates to a computer-readable medium, having stored thereon a computer program executable by a computing device, the computer program comprising code for executing a method according to any of the embodiments of the disclosure. This includes data i/o drivers for low-latency hardware, programs to configure the low-latency hardware to perform image-processing functionality, programs to perform error-checks, etc.

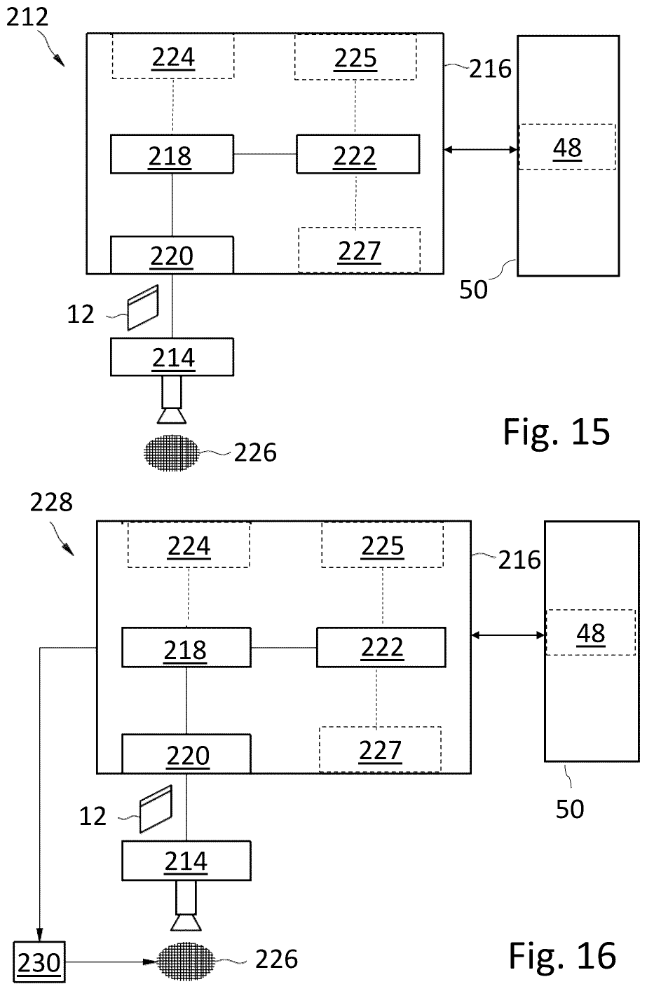

FIG. 15 schematically illustrates a system 212, which can be used for controlling the quality of wafers 226 produced in a semiconductor manufacturing fab. The system 212 includes an imaging device 214 and a processing device 216. The imaging device 214 is coupled to the processing device 216. The imaging device 214 is configured to acquire imaging datasets 12 of a wafer 226. A wafer 226 can include semiconductor structures, e.g., transistors such as field effect transistors, memory cells, et cetera. An example implementation of the imaging device 214 would be a SEM or multibeam SEM, a Helium ion microscope (HIM) or a cross-beam device including FIB and SEM or any charged particle beam imaging device. The processing device 216 is coupled to at least one embedded system 50 comprising a programmable memory 48.

The imaging device 214 can provide an imaging dataset 12 to the processing device 216. The processing device 216 includes a processor, e.g., implemented as a CPU 218 or GPU. The processor can receive the imaging dataset 12 via an interface 220. The processor can load program code from a memory 222. The processor can execute the program code. Upon executing the program code, the processor performs techniques such as described herein, e.g., assessing the quality of the wafer based on the one or more measurements and at least one quality assessment rule, defect recognition, transferring model data to the programmable memory 48 of the embedded system 50, training a machine learning model 40, 40′, 40″, specifying a flow of data 74 through a number of local block circuits 72, 72′, 72″, 72′″, 76, 76′, 76″, 76′″ of an embedded system 50, 50′, applying a machine learning model 42 implemented on an embedded system 50, 50′ to data, taking measurements of recognized defects 16, optimizing at least one image acquisition parameter etc. For example, the processor can perform the computer implemented method shown in FIG. 2, FIG. 4, FIG. 10, FIG. 11, FIG. 12, FIG. 13 respectively upon loading program code from the memory 222. The processing device 216 can optionally contain a user interface 224 for receiving user input, e.g., defect measurement types, quality assessment rules, parameters for machine learning models, etc. The processing device 216 can optionally contain a display device 227 for displaying defect recognition results to a user, e.g., in real-time or buffered. The processing device 216 can also optionally contain a database 225 for saving, for example, families of machine learning models 40, 40′, 40″, 40′″, model architectures 42 or model data 44, 44′, 44″ of different trained machine learning models 40, 40′, 40″, etc.

FIG. 16 schematically illustrates a system 228, which can be used for controlling the production of wafers 226 in a semiconductor manufacturing fab. The system 228 comprises the same components as indicated in FIG. 15 and the above the also applies for the respective components here. In addition, the system 228 has a mechanism 230 for producing wafers 226 controlled by at least one wafer manufacturing process parameter. To this end, an imaging dataset 12 is provided to the processing device 216 via the imaging device 214. The processor of the processing device 216 is configured to perform one of the disclosed methods according to a first, second or third embodiment of the disclosure, comprising controlling the at least one wafer manufacturing process parameter based on one or more measured properties of the recognized defects 16 in the imaging dataset 12 of the wafer 226. For example, detected bridge defects 16 indicate insufficient etching, so the amount of etching is increased, detected line break defects 16 indicate excessive etching, so the amount of etching is decreased, consistently occurring anomalies or defects 16 indicate a defective mask, so the mask is checked, and anomalies or defects 16 due to missing structures hint at non-ideal material deposition, so the material deposition is modified.

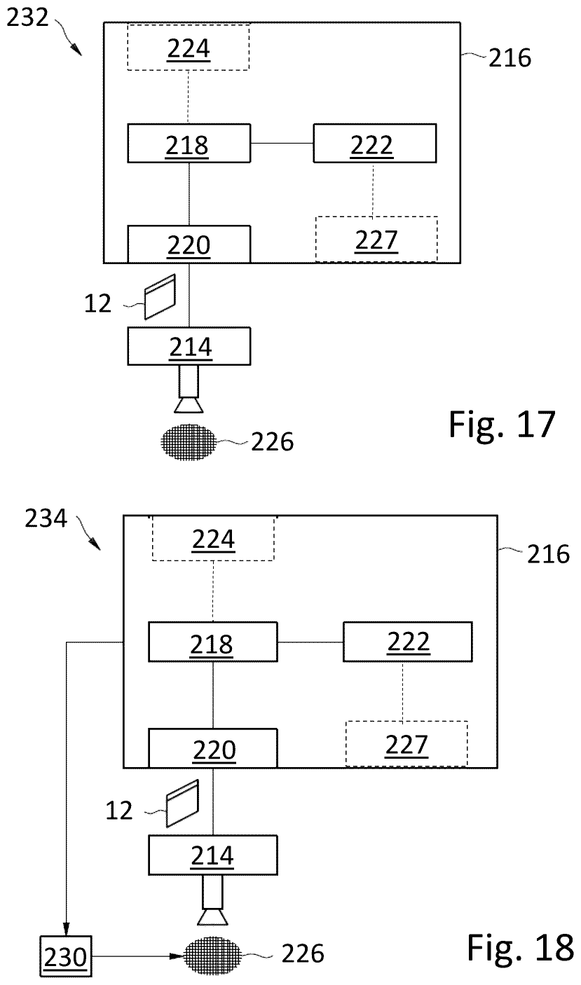

FIG. 17 schematically illustrates a system 232, which can be used for controlling the quality of wafers 226 produced in a semiconductor manufacturing fab. The system 232 includes an imaging device 214 and a processing device 216. The imaging device 214 is coupled to the processing device 216. The imaging device 214 is configured to acquire imaging datasets 12 of a wafer 226. A wafer 226 can include semiconductor structures, e.g., transistors such as field effect transistors, memory cells, et cetera. An example implementation of the imaging device 214 would be a SEM or multibeam SEM, a Helium ion microscope (HIM) or a cross-beam device including FIB and SEM or any charged particle imaging device.

The imaging device 214 can provide an imaging dataset 12 to the processing device 216. The processing device 216 includes a processor, e.g., implemented as a CPU 218 or GPU. The processor can receive the imaging dataset 12 via an interface 220. The processor can load program code from a memory 222. The processor can execute the program code. Upon executing the program code, the processor performs techniques such as described herein according to a fourth embodiment of the disclosure, e.g., defect recognition, taking measurements of recognized defects, optimizing at least one image acquisition parameter jointly with the model architecture of a machine learning model. For example, the processor can perform the computer implemented method shown in FIG. 14 upon loading program code from the memory 222. The processing device 216 can optionally contain a user interface 224 for receiving user input, e.g., defect measurement types, quality assessment rules, parameters for machine learning models, etc. The processing device 216 can optionally contain a display device 227 for displaying defect recognition results to a user, e.g., in real-time or buffered.

FIG. 18 schematically illustrates a system 234, which can be used for controlling the production of wafers 226 in a semiconductor manufacturing fab. The system 228 comprises the same components as indicated in FIG. 17 and the above the also applies for the respective components here. In addition, the system 234 has a mechanism 230 for producing wafers 226 controlled by at least one wafer manufacturing process parameter. To this end, an imaging dataset 12 is provided to the processing device 216 via the imaging device 214. The processor of the processing device 216 is configured to perform one of the disclosed methods comprising controlling the at least one wafer manufacturing process parameter based on one or more measured properties of the recognized defects 16 in the imaging dataset 12 of the wafer 226. For example, detected bridge defects 16 indicate insufficient etching, so the amount of etching is increased, detected line break defects 16 indicate excessive etching, so the amount of etching is decreased, consistently occurring anomalies or defects 16 indicate a defective mask, so the mask is checked, and anomalies or defects 16 due to missing structures hint at non-ideal material deposition, so the material deposition is modified.

Embodiments, examples and aspects of the disclosure can be described by the following clauses:

1. Computer implemented method 22 for defect recognition in an imaging dataset 12, 12′, 12″ of a wafer 226 in a charged particle beam system 78 comprising an embedded system 50, 50′, the method comprising:
i. Obtaining an imaging dataset 12, 12′, 12″ of a wafer 226;
ii. Obtaining model data 44, 44′, 44″ for a model architecture 42 of a machine learning model 40, 40′, 40″ for defect recognition in the imaging dataset 12, 12′, 12″ of the wafer 226, the model architecture 42 being implemented in the embedded system 50, 50′;
iii. Transferring the model data 44, 44′, 44″ to a programmable memory 48, 48′, 48″ of the embedded system 50, 50′;
iv. Applying the machine learning model 40, 40′, 40″ to an imaging dataset 12, 12′, 12″ of a wafer 226 to recognize defects 16, comprising executing the embedded system implemented model architecture 46 with the transferred model data 44, 44′, 44″.

2. Computer implemented method 52 for defect recognition in an imaging dataset 12, 12′, 12″ of a wafer 226 in a charged particle beam system 78 comprising at least one embedded system 50, 50′, the method comprising:
i. Obtaining an imaging dataset 12, 12′, 12″ of a wafer 226;
ii. Defining an embedded system implemented model architecture 46 of a machine learning model 40, 40′, 40″ for defect recognition in the imaging dataset 12, 12′, 12″ of the wafer 226 by specifying a flow of data 74 through a number of logic block circuits 72′, 72′″ of a plurality of logic block circuits 72, 72′, 72″, 72′″, 74, 74′, 74″, 74′″ on one of the at least one embedded systems 50, 50′, wherein the plurality of logic block circuits 72, 72′, 72″, 72′″, 74, 74′, 74″, 74′″ comprise one or more modules 102, 104 of at least one model architecture 42 of at least one machine learning model 40, 40′, 40″ for defect recognition;
iii. Obtaining model data 44, 44′, 44″ for the embedded system implemented model architecture 46;
iv. Transferring the model data 44, 44′, 44″ to a programmable memory 48, 48′, 48″ of the embedded system 50, 50′;
v. Applying the machine learning model 40, 40′, 40″ to the imaging dataset 12, 12′, 12″ of a wafer 226 to recognize defects 16, comprising executing the embedded system implemented model architecture 46 with the transferred model data 44, 44′, 44″.

3. Computer implemented method according to clause 2, wherein the at least one model architecture 42 of the at least one machine learning model 40, 40′, 40″ for defect recognition comprises a model architecture 42 of a neural network 114.

4. Computer implemented method according to clause 3, wherein one or more modules 102, 104 are head modules 116, 124, 126, a head module 116, 124, 126 being a module comprising an output layer 120 of a neural network 114.

5. Computer implemented method according to clause 4, wherein the one or more head modules 116, 124, 126 comprise a fully connected output layer of a neural network 114 and/or a convolutional output layer of a neural network 114.

6. Computer implemented method according to any one of clauses 3 to 5, wherein one or more modules 102, 104 are tail modules 118, 128, 130, 132, 134, 136, 138, a tail module 118, 128, 130, 132, 134, 136, 138 being a module comprising a number of hidden layers 122 of a neural network 114.

7. Computer implemented method according to clause 6, wherein at least one tail module 118, 128, 130, 132, 134, 136, 138, in particular each tail module 118, 128, 130, 132, 134, 136, 138, comprises all hidden layers 122 of a neural network 114.

8. Computer implemented method according to clause 6 or 7, wherein at least one tail module 118, 128, 130, 132, 134, 136, 138, in particular each tail module 118, 128, 130, 132, 134, 136, 138, comprises a number of hidden layers 122 forming a semantic entity.

9. Computer implemented method according to any one of clauses 6 to 8, wherein at least two of the tail modules 118, 128, 130, 132, 134, 136, 138 contain the same number of hidden layers 122, 123 and the sizes of the feature maps of corresponding layers 129, 129′, 131, 131′, 133, 133′ differ by the same factor.

10. Computer implemented method according to any one of clauses 3 to 9, wherein each module 102, 104 of the one or more modules 102, 104 is either a head module 116, 124, 126, comprising an output layer 120 of a neural network 114, or a tail module 118, 128, 130, 132, 134, 136, 138, comprising a number of hidden layers 122 of a neural network 114.

11. Computer implemented method according to any one of the clause 3 to 10, wherein the one or more modules 102, 104 are generated from at least one model architecture 42 of a neural network 114 by partitioning each model architecture 42 into a head module 116, 124, 126 comprising an output layer 120 of the neural network 114 and at least one tail module 118, 128, 130, 132, 134, 136, 138 comprising a number of hidden layers 122 of the neural network 114.

12. Computer implemented method according to clause 11, wherein each model architecture 42 of a neural network 114 is partitioned into a task specific head module 116, 124, 126 and a single tail module 118, 128, 130, 132, 134, 136, 138.

13. Computer implemented method according to any one of clauses 2 to 12, further comprising, prior to specifying the flow of data 74 through the number of logic block circuits 72′, 72′″ of the plurality of logic block circuits 72, 72′, 72″, 72′″, 74, 74′, 74″, 74′″, determining if the model architecture 42 of the machine learning model 40, 40′, 40″ can be realized by the plurality of logic block circuits 72, 72′, 72″, 72′″, 74, 74′, 74″, 74′″ on one of the at least one embedded systems 50, 50′; in response to determining that the model architecture 42 cannot be realized, generating one or more modules 102, 104 of the model architecture 42 of the machine learning model 40, 40′, 40″ and implementing the one or more modules 102, 104 on one of the at least one embedded systems 50, 50′.

14. Computer implemented method according to any one of the preceding clauses, wherein the machine learning model 40, 40′, 40″ for defect recognition is from the group comprising defect detection models, defect classification models, defect localization models, defect segmentation models, anomaly detection models, anomaly classification models, anomaly localization models, anomaly segmentation models.

15. Computer implemented method according to any of the preceding clauses, wherein the model data 44, 44′, 44″ for the embedded system implemented model architecture 46 is obtained by training a machine learning model 40, 40′, 40″ comprising the model architecture.

16. Computer implemented method according to any one of the preceding clauses, wherein the model data 44, 44′, 44″ for the embedded system implemented model architecture 46 is loaded from a database 225.

17. Computer implemented method according to any one of the preceding clauses, wherein the model data 44, 44′, 44″ for the embedded system implemented model architecture 46 is provided by an external service.

18. Computer implemented method according to any one of the preceding clauses, wherein the model data 44, 44′, 44″ is transferred to the programmable memory 48, 48′, 48″ of the embedded system 50, 50′ by copying.

19. Computer implemented method according to any one of the preceding clauses, wherein the model data 44, 44′, 44″ is transferred to the programmable memory 48, 48′, 48″ of the embedded system 50, 50′ by replacing the hardware block comprising the programmable memory 48, 48′, 48″ of the embedded system 50, 50′ by a new hardware block comprising the model data 44, 44′, 44″ to be transferred.

20. Computer implemented method 22, 52 according to any one of the preceding clauses, wherein the recognized defects 16 are directed to a display device 227 or dashboard.

21. Computer implemented method according to any one of the preceding clauses, wherein the recognized defects 16 are stored in a long-term memory.

22. Computer implemented method according to any one of the preceding clauses, wherein the recognized defects 16 are cached into a memory.

23. Computer implemented method according to any one of the preceding clauses, wherein the recognized defects 16 are analyzed in order to update the embedded system implemented model architecture 46 in step ii.

24. Computer implemented method according to any one of the preceding clauses, wherein the embedded system 50, 50′ is a field programmable gate array 51.

25. Computer implemented method 182 according to any one of the preceding clauses, further comprising, prior to obtaining an imaging dataset 12, 12′, 12″ of a wafer in step i, the following steps:
Iterating the following steps until a convergence criterion is met:
   Selecting at least one image acquisition parameter according to an imaging sampling strategy and acquiring an imaging dataset 12, 12′, 12″ of a wafer 226 based on the at least one image acquisition parameter;
   Generating training data from the acquired imaging dataset 12, 12′, 12″ of the wafer 226;
   Selecting a model architecture 42 and training an associated machine learning model 40, 40′, 40″ based on the generated training data;
   Determining the quality of the model architecture 42 and the at least one image acquisition parameter by computing an associated objective function value of an objective function evaluating the quality of the trained machine learning model 40, 40′, 40″;
Based on the objective function values, selecting one of the model architectures 42 and the corresponding at least one image acquisition parameter,
wherein
the imaging dataset 12, 12′, 12″ of the wafer 226 in step i is obtained based on the selected at least one image acquisition parameter, and the embedded system implemented model architecture 46 in step ii comprises the model architecture 42 of the selected machine learning model 40, 40′, 40″.

26. Computer implemented method according to clause 25, wherein the step of selecting a model architecture 42 comprises selecting at least one hyperparameter defining the model architecture 42 of the machine learning model 40, 40′, 40″ according to an architecture sampling strategy.

27. Computer implemented method according to clause 26, wherein the objective function comprises a measure of complexity of the model architecture 42.

28. Computer implemented method according to any one of clauses 25 to 27, wherein the objective function comprises a measure of runtime and/or a measure of throughput and/or a data rate and/or a measure of power consumption.

29. Computer implemented method according to any one of clauses 25 to 28, wherein the objective function comprises a measure of quality of the defect recognition.

30. Computer implemented method according to any one of clauses 25 to 29, wherein the at least one image acquisition parameter is from the group comprising imaging time, image resolution, pixel size, landing energy and dwell time of electron waves.

31. Computer implemented method according to any one of clauses 25 to 30, wherein the objective function comprises a measure of the bit-volume of the input data of the machine learning model 40, 40′, 40″.

32. Computer implemented method 196 for defect recognition in an imaging dataset 12, 12′, 12″ of a wafer 226, the method comprising:
Iterating the following steps until a convergence criterion is met:
   Selecting at least one image acquisition parameter according to an imaging sampling strategy and acquiring an imaging dataset 12, 12′, 12″ of a wafer 226 based on the at least one image acquisition parameter;
   Generating training data from the acquired imaging dataset 12, 12′, 12″ of the wafer 226;
   Selecting a model architecture 42 and training an associated machine learning model 40, 40′, 40″ based on the generated training data;
   Evaluating the quality of the trained machine learning model 40, 40′, 40″ by computing an associated objective function value of an objective function;
Based on the objective function values, selecting one of the trained machine learning models 40, 40′, 40″;
Applying the selected trained machine learning model 40, 40′, 40″ to an imaging dataset 12, 12′, 12″ of a wafer 226 acquired based on the corresponding at least one image acquisition parameter, in order to recognize defects 16.

33. Computer implemented method according to clause 32, wherein the step of selecting a model architecture 42 comprises selecting at least one hyperparameter defining the model architecture 42 of the machine learning model 40, 40′, 40″ according to an architecture sampling strategy.

34. Computer implemented method according to clause 33, wherein the objective function comprises a measure of complexity of the model architecture 42.

35. Computer implemented method according to any one of clauses 32 to 34, wherein the objective function comprises a measure of runtime and/or a measure of throughput and/or a data rate and/or a measure of power consumption during defect recognition.

36. Computer implemented method according to any one of clauses 32 to 35, wherein the objective function comprises a measure of quality of the defect recognition.

37. Computer implemented method according to any one of clauses 32 to 36, wherein the at least one image acquisition parameter is from the group comprising imaging time, image resolution, pixel size, landing energy and dwell time of electron waves.

38. Computer implemented method according to any one of clauses 32 to 37, wherein the objective function comprises a measure of the bit-volume of the input to the machine learning model 40, 40′, 40″.

39. Computer implemented method according to any one of clauses 1 to 31, further comprising determining one or more measurements of the recognized defects 16 in the imaging dataset 12, 12′, 12″ of the wafer 226, in particular size, area, dimension, shape parameters, distance, radius, aspect ratio, type, number of defects, density, spatial distribution of defects, etc.

40. Computer implemented method according to clause 39, further comprising assessing the quality of the wafer 226 based on the one or more measurements and at least one quality assessment rule.

41. Computer implemented method according to clause 39, further comprising controlling at least one wafer manufacturing process parameter based on one or more measurements of the recognized defects in the imaging dataset of the wafer.

42. Computer implemented method according to any one of clauses 32 to 38, further comprising determining one or more measurements of the recognized defects 16 in the imaging dataset 12, 12′, 12″ of the wafer 226, in particular size, area, dimension, shape parameters, distance, radius, aspect ratio, type, number of defects, density, spatial distribution of defects, existence of any defects, etc.

43. Computer implemented method according to clause 42, further comprising assessing the quality of the wafer 226 based on the one or more measurements and at least one quality assessment rule.

44. Computer implemented method according to clause 42, further comprising controlling at least one wafer manufacturing process parameter based on one or more measurements of the recognized defects 16 in the imaging dataset 12, 12′, 12″ of the wafer 226.

45. Computer-readable medium, having stored thereon a computer program executable by a computing device, the computer program comprising code for executing a method of any one of clauses 1 to 44.

46. Computer program product comprising instructions which, when the program is executed by a computer, cause the computer to carry out a method of any one of clauses 1 to 44.

47. System 212 for controlling the quality of wafers 226 produced in a semiconductor manufacturing fab, the system 212 comprising:
an imaging device 214 adapted to provide an imaging dataset 12, 12′, 12″ of a wafer 226;
one or more processing devices 216;
at least one embedded system 50, 50′;
one or more machine-readable hardware storage devices comprising instructions that are executable by one or more processing devices 216 to perform operations comprising the method of clause 40.

48. System 228 for controlling the production of wafers 226 in a semiconductor manufacturing fab, the system 228 comprising:
means 230 for producing wafers 226 controlled by at least one manufacturing process parameter;
an imaging device 214 adapted to provide an imaging dataset 12, 12′, 12″ of a wafer 226;
one or more processing devices 216;
at least one embedded system 50, 50′
one or more machine-readable hardware storage devices comprising instructions that are executable by one or more processing devices 216 to perform operations comprising the method of clause 41.

49. System 212, 228 according to clause 47 or 48, further comprising a database 225.

50. System 232 for controlling the quality of wafers 226 produced in a semiconductor manufacturing fab, the system 232 comprising:
an imaging device 214 adapted to provide an imaging dataset 12, 12′, 12″ of a wafer 226;
one or more processing devices 216;
one or more machine-readable hardware storage devices comprising instructions that are executable by one or more processing devices 216 to perform operations comprising the method of clause 43.

51. System 234 for controlling the production of wafers 226 in a semiconductor manufacturing fab, the system 234 comprising:
means 230 for producing wafers 226 controlled by at least one manufacturing process parameter;
an imaging device 214 adapted to provide an imaging dataset 12, 12′, 12″ of a wafer 226;
one or more processing devices 216;
one or more machine-readable hardware storage devices comprising instructions that are executable by one or more processing devices 216 to perform operations comprising the method of clause 44.

52. System 212, 228, 232, 234 according to any one of clauses 47 to 51, further comprising a display device 227.

53. System 212, 228, 232, 234 according to any one of clauses 47 to 52, further comprising a user interface 224.

### REFERENCE NUMBER LIST

10, 10′, 10″ Cell structure
12, 12′, 12″ Imaging dataset
14, 14′, 14″ Cell
16 Defect
22 Computer implemented method
26 Imaging step
28 Model data step
30 Model data transfer step
32 Application step
34 New use-case
40, 40′, 40″ Machine learning model
42 Model architecture
44, 44′, 44″ Model data
46 embedded system implemented model architecture
48, 48′, 48″ Programmable memory
50, 50′ Embedded system
51 Field programmable gate array
52 Computer implemented method
56 Imaging step
58 Data flow specification step
60 Model data step
62 Model data transfer step
64 Application step
66 New use-case
72, 72′, 72″, 72′″ Logic block circuits
74 Flow of data
76, 76′, 76″, 76′″ Logic block circuits
78 Charged particle beam system
80 Adaptive logic modules
82 M512 block
84 M4K block
86 High-speed I/O channels with dynamic phase alignment (DPA)
88 I/O channels with external memory interface circuitry
90 Digital signal processing blocks
92 M-RAM blocks
94 Phase locked loops
96 Programmable memory
98 Input data bus
100 Weights
102 First module
104 Second module
106 Configure memory
108 Multiplexer
110 Multiplication
112 Addition
114 Neural network
116 Head module
118 Tail module
120 Output layer
122 Hidden layer
123 Final hidden layer
124 Head module
126 Head module
128 Tail module
129, 129′ Corresponding first layer
130 Tail module
131, 131′ Corresponding second layer
132 Tail module
133, 133′ Corresponding third layer
134 Tail module
136 Tail module
138 Tail module
142 Start
144 Family decision
146 Use-case decision
148 Problem casting step
150 Data acquisition and training step
152 Model data saving step
154 Use-case collection step
156 Model architecture definition step
158 Realizability step
160 Model implementation step
162 Model data lookup step
164 Model data transfer step
166 Data processing step
168 stop
170 Yes
172 No
174 Yes
176 No
178 Yes
180 no
182 Computer implemented method
184 Image acquisition parameter step
186 Training data generation step
188 Machine learning model training step
190 Quality evaluation step
192 Selection step
194 Iteration
196 Computer implemented method
198 Image acquisition parameter step
200 Training data generation step
202 Machine learning model training step
204 Quality evaluation step
206 Selection step
208 Application step
210 Iteration
212 System
214 Imaging device
216 Processing device
218 CPU
220 Interface
222 Memory
224 User interface
225 Database
226 Wafer
227 Display device
228 System
230 Mechanism
232 System
234 System

1. A computer implemented method, comprising:
obtaining an imaging dataset of a wafer;
obtaining model data for a model architecture of a machine learning model for defect recognition in the imaging dataset of the wafer, the model architecture being implemented in the embedded system;
transferring the model data to a programmable memory of the embedded system; and
applying the machine learning model to an imaging dataset of a wafer to recognize defects, comprising executing the embedded system implemented model architecture with the transferred model data.

2. A computer implemented method, comprising:
obtaining an imaging dataset of a wafer;
defining an embedded system implemented model architecture of a machine learning model for defect recognition in the imaging dataset of the wafer by specifying a flow of data through a number of logic block circuits of a plurality of logic block circuits on one of the at least one embedded systems, the plurality of logic block circuits comprising one or more modules of at least one model architecture of at least one machine learning model for defect recognition;
obtaining model data for the embedded system implemented model architecture;
transferring the model data to a programmable memory of the embedded system; and
applying the machine learning model to the imaging dataset of a wafer to recognize defects, comprising executing the embedded system implemented model architecture with the transferred model data.

3. The computer implemented method of claim 2, wherein a model architecture of the at least one machine learning model for defect recognition comprises a model architecture of a neural network.

4. The computer implemented method of claim 3, wherein a module comprises a head module, and the head module comprises an output layer of a neural network.

5. The computer implemented method of claim 4, wherein head module comprises a fully connected output layer of a neural network and/or a convolutional output layer of a neural network.

6. The computer implemented method of claim 3, wherein a modules comprises a tail module, and the tail module comprises a number of hidden layers of a neural network.

7. The computer implemented method of claim 6, wherein at tail module comprises all hidden layers of a neural network.

8. The computer implemented method of claim 6, wherein the tail module comprises a number of hidden layers forming a semantic entity.

9. The computer implemented method of claim 6, wherein at least two of the tail modules contain the same number of hidden layers and the sizes of the feature maps of corresponding layers differ by the same factor.

10. The computer implemented method of claim 3, wherein each module comprises: i) a head module comprising an output layer of a neural network; or ii) a tail module comprising a number of hidden layers of a neural network.

11. The computer implemented method of claim 3, wherein the one or more modules are generated from at least one model architecture of a neural network by partitioning each model architecture into a head module comprising an output layer of the neural network and at least one tail module comprising a number of hidden layers of the neural network.

12. The computer implemented method of claim 11, wherein each model architecture of a neural network is partitioned into a task specific head module and a single tail module.

13. The computer implemented method of claim 2, further comprising, prior to specifying the flow of data through the number of logic block circuits of the plurality of logic block circuits: determining whether the model architecture of the machine learning model is realizable by the plurality of logic block circuits on one of the at least one embedded systems; and ii) in response to determining that the model architecture is not realizable, generating one or more modules of the model architecture of the machine learning model and implementing the one or more modules on one of the at least one embedded systems.

14. The computer implemented method of claim 2, wherein at least one of the following holds:
the machine learning model for defect recognition comprises a member selected from the group consisting of defect detection models, defect classification models, defect localization models, defect segmentation models, anomaly detection models, anomaly classification models, anomaly localization models, and anomaly segmentation models;
the model data for the embedded system implemented model architecture is obtained by training a machine learning model comprising said model architecture;
the model data for the embedded system implemented model architecture is loaded from a database;
the model data for the embedded system implemented model architecture is provided by an external service;
the model data is transferred to the programmable memory of the embedded system by copying
the model data is transferred to the programmable memory of the embedded system by replacing the hardware block comprising the programmable memory of the embedded system by a new hardware block comprising the model data to be transferred;
the recognized defects are directed to a display device or dashboard;
the recognized defects are stored in a long-term memory;
the recognized defects are cached into a memory;
during defining the embedded system, the recognized defects are analyzed to update the embedded system implemented model architecture;
the embedded system is a field programmable gate array.

15. The computer implemented method of claim 2, further comprising, prior to obtaining an imaging dataset:
iterating the following steps until a convergence criterion is met:
selecting at least one image acquisition parameter according to an imaging sampling strategy and acquiring an imaging dataset of a wafer based on the at least one image acquisition parameter;
generating training data from the acquired imaging dataset of the wafer;
selecting a model architecture and training an associated machine learning model based on the generated training data;
determining the quality of the model architecture and the at least one image acquisition parameter by computing an associated objective function value of an objective function evaluating the quality of the trained machine learning model; and b
based on the objective function values, selecting one of the model architectures and the corresponding at least one image acquisition parameter,
wherein the imaging dataset of the wafer is obtained based on the selected at least one image acquisition parameter, and the embedded system implemented model architecture comprises the model architecture of the selected machine learning model.

16. The computer implemented method of claim 15, wherein at least one of the following holds:
selecting the model architecture comprises selecting at least one hyperparameter defining the model architecture of the machine learning model according to an architecture sampling strategy;
the objective function comprises a measure of runtime and/or a measure of throughput and/or a data rate and/or a measure of power consumption;
the objective function comprises a measure of quality of the defect recognition;
the at least one image acquisition parameter is from the group comprising imaging time, image resolution, pixel size, landing energy and dwell time of electron waves; and
the objective function comprises a measure of the bit-volume of the input data of the machine learning model.

17. The computer implemented method of claim 2, further comprising determining one or more measurements of the recognized defects in the imaging dataset.

18. One or more machine-readable hardware storage devices comprising instructions that are executable by one or more processing devices to perform operations comprising the method of claim 2.

19. A system, comprising:
one or more processing devices; and
one or more machine-readable hardware storage devices comprising instructions that are executable by one or more processing devices to perform operations comprising the method of claim 2.

20. A computer implemented method, comprising:
iterating the following steps until a convergence criterion is met:
selecting at least one image acquisition parameter according to an imaging sampling strategy and acquiring an imaging dataset of a wafer based on the at least one image acquisition parameter;
generating training data from the acquired imaging dataset of the wafer;
selecting a model architecture and training an associated machine learning model based on the generated training data;
evaluating the quality of the trained machine learning model by computing an associated objective function value of an objective function;
based on the objective function values, selecting one of the trained machine learning models; and
applying the selected trained machine learning model to an imaging dataset of a wafer acquired based on the corresponding at least one image acquisition parameter, in order to recognize defects.
